(19) United States
(12) Patent Application Publication
(10) Pub. No.: US 2025/0232632 A1
(43) Pub. Date: Jul. 17, 2025

(54) DRUG PACKAGING SYSTEM

(71) Applicant: YUYAMA MFG. CO., LTD., Toyonaka-shi (JP)

(72) Inventors: Norifumi OIKE, Toyonaka-shi (JP); Koji YAMASHITA, Toyonaka-shi (JP); Hideyuki TATE, Toyonaka-shi (JP); Yoshikazu TAJIMA, Toyonaka-shi (JP)

(73) Assignee: YUYAMA MFG. CO., LTD., Toyonaka-shi (JP)

(21) Appl. No.: 19/097,903

(22) Filed: Apr. 2, 2025

Related U.S. Application Data
(63) Continuation of application No. PCT/JP2023/036287, filed on Oct. 4, 2023.

(30) Foreign Application Priority Data
Oct. 7, 2022 (JP) 2022-162710

(51) Int. Cl. G07F 17/00; B65B 35/02; B65B 35/44

(52) U.S. Cl. CPC G07F 17/0092; B65B 35/02; B65B 35/44

(57) ABSTRACT

A drug packaging system according to one or more embodiments may include: a first storage area that stores a cassette containing drugs and dispenses the drugs from the stored cassette, a second storage area that stores the cassette to be conveyed to the first storage area, a first conveyor that conveys the cassette within the second storage area, a second conveyor that conveys the cassette from the second storage area to the first storage area, and a packaging unit that package the drugs dispensed from the cassette stored in the first storage area into a package for each dosage unit.

### CROSS REFERENCE TO RELATED APPLICATIONS

This application is a continuation application of International Application No. PCT/JP2023/036287, filed on Oct. 4, 2023, which claims priority to prior Japanese Patent Application No. 2022-162710 filed with the Japan Patent Office on Oct. 7, 2022, the entire contents of which are incorporated herein by reference.

### BACKGROUND

The disclosure relates to a drug packaging system.

The U.S. Patent Application Publication No. 2013-0318931 to Holmes (“Holmes”) discloses a pharmacy packaging system including: a storage unit for storing a plurality of cassettes that contain pharmaceuticals; and packaging units provided adjacent to the storage unit. In the pharmacy packaging system disclosed in Holmes, the storage unit includes: shelves for storing the cassettes; and a gantry assembly that is moved along the shelves to retrieve the cassettes from the shelves. Motor bases arranged offset from the shelves include ledges for supporting active cassettes. The pharmaceuticals are supplied from the active cassettes supported by the ledges to the packaging units through chutes.

### SUMMARY

In the pharmacy packaging system disclosed in Holmes, the gantry moves the cassettes from the shelves to the ledges. The pharmaceuticals are dispensed from the active cassettes supported by the ledges. When there is no vacancy in the ledges, the cassettes cannot be moved to the ledges. Thus, it may be difficult to convey the cassettes on a flexible schedule.

According to one aspect of the present disclosure, there is provided a drug packaging system including: a first storage area for storing a cassette containing drugs and for dispensing the drugs from the stored cassette; a second storage area for storing the cassette to be conveyed to the first storage area; a first conveyor configured to convey the cassette within the second storage area; a second conveyor configured to convey the cassette from the second storage area to the first storage area; and a packaging unit configured to package the drugs dispensed from the cassette stored in the first storage area, in a packaging body for each dose unit.

According to another aspect of the present disclosure, there is provided a drug packaging system including: a storage cylinder having a columnar shape and being rotatable in a circumferential direction, the storage cylinder being for storing a plurality of cassettes containing drugs and for dispensing the drugs from the stored cassettes; a storage area, which is adjacent to the storage cylinder, and in which a plurality of cassettes are allowed to be stored; a conveyor configured to convey the cassette between the storage cylinder and the storage area; and a packaging unit configured to package the drugs dispensed from the cassette stored in the storage cylinder, in a packaging body.

The present disclosure can be embodied not only as a drug packaging system having the characteristic configuration as described above but also as a cassette conveying apparatus included in the drug packaging system, a cassette conveying method including a characteristic cassette conveying process performed in the drug packaging system as a step, or a control device that controls the conveyance of cassettes in the drug packaging system. The present disclosure can be embodied as a computer program for causing a computer to function as the control device, or the present disclosure can embody a part or the entirety of the control device as a semiconductor integrated circuit.

According to one or more embodiments, cassettes may be conveyed on a flexible schedule in order to efficiently package drugs.

### BRIEF DESCRIPTION OF THE DRAWINGS

FIG. 1 is a diagram illustrating a plan view a configuration of a drug packaging system according to one or more embodiments.

FIG. 2 is a diagram illustrating a front view of a drug packaging system according to one or more embodiments.

FIG. 3 is a diagram illustrating a plan view of a configuration of a cassette accommodating portion according to one or more embodiments.

FIG. 4 is a diagram illustrating a perspective view of a bottom surface of a cassette according to one or more embodiments.

FIG. 5 is a diagram illustrating a front view of a cassette according to one or more embodiments.

FIG. 6 is a diagram illustrating a side view of the cassette according to one or more embodiments.

FIG. 7 is a diagram illustrating a sectional view taken along the line A-A of FIG. 1 as viewed in the direction of arrows.

FIG. 8 is a diagram illustrating a sectional view taken along the line B-B of FIG. 1 as viewed in the direction of arrows.

FIG. 9 is a diagram illustrating a perspective view of a configuration of a conveyance head according to one or more embodiments.

FIG. 10 is a diagram illustrating a front view of a configuration of a conveyance head according to one or more embodiments.

FIG. 11 is a diagram illustrating a plan view of a configuration of a stand according to one or more embodiments.

FIG. 12 is a diagram illustrating a perspective view of a positional relationship between a storage cylinder and a second conveyor according to one or more embodiments.

FIG. 13 is a diagram illustrating a plan view of a configuration of a pushing mechanism according to one or more embodiments.

FIG. 14A is a diagram illustrating a view of conveyance of the cassette performed by a second conveyor according to one or more embodiments.

FIG. 14B is a diagram illustrating a view for illustrating of a conveyance of a cassette performed by a second conveyor according to one or more embodiments.

FIG. 14C is a diagram illustrating a view of a conveyance of a cassette performed by a second conveyor according to one or more embodiments.

FIG. 15A is a diagram illustrating an explanatory plan view for illustrating a first carry-in operation according to one or more embodiments.

FIG. 15B is a diagram illustrating an explanatory side view of a first carry-in operation according to one or more embodiments.

FIG. 15C is a diagram illustrating an explanatory plan view of a first carry-in operation according to one or more embodiments.

FIG. 15D is a diagram illustrating an explanatory plan view of a first carry-in operation according to one or more embodiments.

FIG. 15E is a diagram illustrating an explanatory plan view of a first carry-in operation according to one or more embodiments.

FIG. 15F is a diagram illustrating an explanatory plan view of a first carry-in operation according to one or more embodiments.

FIG. 15G is a diagram illustrating an explanatory side view of a first carry-in operation according to one or more embodiments.

FIG. 15H is a diagram illustrating an explanatory plan view of a first carry-in operation according to one or more embodiments.

FIG. 16A is a diagram illustrating an explanatory side view of a first carry-out operation according to one or more embodiments.

FIG. 16B is a diagram illustrating an explanatory plan view of a first carry-out operation according to one or more embodiments.

FIG. 16C is a diagram illustrating an explanatory plan view of a first carry-out operation according to one or more embodiments.

FIG. 16D is a diagram illustrating an explanatory side view of a first carry-out operation according to one or more embodiments.

FIG. 16E is a diagram illustrating an explanatory plan view of a first carry-out operation according to one or more embodiments.

FIG. 16F is a diagram illustrating an explanatory plan view of a first carry-out operation according to one or more embodiments.

FIG. 16G is a diagram illustrating an explanatory plan view of a first carry-out operation according to one or more embodiments.

FIG. 16H is a diagram illustrating an explanatory plan view of a first carry-out operation according to one or more embodiments.

FIG. 17A is a diagram illustrating an explanatory plan view of a second carry-in operation according to one or more embodiments.

FIG. 17B is an explanatory plan view for illustrating the second carry-in operation.

FIG. 17C is a diagram illustrating an explanatory plan view of a second carry-in operation according to one or more embodiments.

FIG. 17D is a diagram illustrating an explanatory plan view of a second carry-in operation according to one or more embodiments.

FIG. 17E is a diagram illustrating an explanatory plan view of a second carry-in operation according to one or more embodiments.

FIG. 17F is a diagram illustrating an explanatory plan view of a second carry-in operation according to one or more embodiments.

FIG. 17G is a diagram illustrating an explanatory plan view of a second carry-in operation according to one or more embodiments.

FIG. 17H is a diagram illustrating an explanatory plan view of a second carry-in operation according to one or more embodiments.

FIG. 18A is a diagram illustrating an explanatory plan view of operations of first rollers and second rollers according to one or more embodiments.

FIG. 18B is a diagram illustrating an explanatory plan view of operations of first rollers and the second rollers.

FIG. 18C is a diagram illustrating an explanatory plan view of operations of first rollers and the second rollers according to one or more embodiments.

FIG. 19A is a diagram illustrating an explanatory plan view of a second carry-out operation according to one or more embodiments.

FIG. 19B is a diagram illustrating an explanatory plan view of a second carry-out operation according to one or more embodiments.

FIG. 19C is a diagram illustrating an explanatory plan view of a second carry-out operation according to one or more embodiments.

FIG. 19D is a diagram illustrating an explanatory plan view of a second carry-out operation according to one or more embodiments.

FIG. 19E is a diagram illustrating an explanatory plan view of a second carry-out operation according to one or more embodiments.

FIG. 19F is a diagram illustrating an explanatory plan view of a second carry-out operation according to one or more embodiments.

FIG. 19G is a diagram illustrating an explanatory plan view of a second carry-out operation according to one or more embodiments.

FIG. 20 is a diagram illustrating an explanatory plan view of conveyance paths for cassettes according to one or more embodiments.

### DETAILED DESCRIPTION

An outline of an embodiment of the present disclosure is listed and described below.

(1) A drug packaging system according to this embodiment includes: a first storage area for storing a cassette containing drugs and for dispensing the drugs from the stored cassette; a second storage area for storing the cassette to be conveyed to the first storage area; a first conveyor configured to convey the cassette within the second storage area; a second conveyor configured to convey the cassette from the second storage area to the first storage area; and a packaging unit configured to package the drugs dispensed from the cassette stored in the first storage area, in a packaging body for each dose unit. With this configuration, before the cassette is conveyed to the first storage area, the cassette can be conveyed within the second storage area. Thus, the cassettes can be conveyed on a flexible schedule in order to efficiently package drugs.

(2) In the above-mentioned item (1), the second storage area may include: a first accommodating position at which the cassette introduced from an outside of the drug packaging system into the drug packaging system is accommodated; and a second accommodating position at which the cassette to be conveyed to the first storage area is accommodated, and the first conveyor may be configured to convey the cassette from the first accommodating position to the second accommodating position. With this configuration, before the cassette is conveyed to the first storage area, the cassette can be temporarily accommodated at the second accommodating position. While the cassette is accommodated at the second accommodating position, another cassette can be accommodated at the first accommodating position and the drugs can be dispensed from the cassette stored in the first storage area. Thus, the cassettes can be conveyed on a flexible schedule.

(3) In the above-mentioned item (2), the second accommodating position may be located between the first storage area and the first accommodating position. With this configuration, the cassette can be efficiently conveyed from the first accommodating position to the first storage area via the second accommodating position that is located between the first accommodating position and the first storage area.

(4) In the above-mentioned item (3), the first storage area may include a plurality of first storage areas arranged in a first direction, and the first accommodating position may be positioned apart from the plurality of first storage areas in a second direction intersecting with the first direction. With this configuration, a difference between distances from the first storage areas to the first accommodating position can be reduced. Thus, the cassette can be efficiently conveyed from the first accommodating position to the first storage areas.

(5) In the above-mentioned item (4), the second accommodating position may include a plurality of second accommodating positions provided so as to correspond to the plurality of first storage areas. With this configuration, the cassettes to be conveyed to the first storage areas can be temporarily accommodated at the second accommodating positions, respectively.

(6) In any one of the above-mentioned items (1) to (5), the second conveyor may be configured to push the cassette from the second storage area into the first storage area. With this configuration, a configuration of the second conveyor can be prevented from being complicated.

(7) In any one of the above-mentioned items (1) to (6), the first storage area may be a storage cylinder having a columnar shape and being rotatable in a circumferential direction. With this configuration, the cassette stored in the first storage area can be moved by rotating the storage cylinder. Thus, the cassette can be more efficiently conveyed.

(8) In the above-mentioned item (7), the storage cylinder may include a plurality of cassette accommodating portions, each being capable of accommodating a cassette, the plurality of cassette accommodating portions may be arranged in the circumferential direction of the storage cylinder, and the second conveyor may be configured to convey the cassette from the second storage area to one of the plurality of cassette accommodating portions. With this configuration, a larger number of cassettes can be stored in the first storage area having a limited size. At the same time, the configuration of the second conveyor can be prevented from being complicated.

(9) In the above-mentioned item (8), when the storage cylinder is rotated in the circumferential direction, the plurality of cassette accommodating portions may be allowed to pass through a specific loading position in order, and the second conveyor may be configured to load the cassette to the cassette accommodating portion located at the loading position, by conveying the cassette from the second storage area to the loading position. With this configuration, the cassette can be conveyed by the second conveyor to any appropriate one of the cassette accommodating portions of the storage cylinder.

(10) In any one of the above-mentioned items (7) to (9), the drug packaging system may further include a third storage area for storing a cassette containing drugs and for dispensing the drugs from the stored cassette, the storage cylinder may include a plurality of storage cylinders arranged in a first direction, and the third storage area may be positioned in a space defined by adjacent two of the storage cylinders. With this configuration, the plurality of storage cylinders and the second storage area can be efficiently arranged, and thus the entirety of the drug packaging system can be downsized.

(11) In the above-mentioned item (10), the drug packaging system may further include a supply unit configured to supply the drugs dispensed from the cassette stored in the first storage area and the drugs dispensed from the cassette stored in the third storage area, to the packaging unit. With this configuration, a wide variety of combinations of drugs can be packaged at a time.

(12) In the above-mentioned item (10) or (11), the cassette stored in the first storage area may be a first cassette containing the same type of drugs, and the cassette stored in the third storage area may be a second cassette containing drugs selectable from a plurality of types of drugs. With this configuration, the first cassette containing a more frequently used drug is stored in the first storage area, and the second cassette containing a less frequently used drug is stored in the third storage area. In this manner, packaging of various types of drugs can be achieved.

(13) In the above-mentioned item (12), the drug packaging system may further include a third conveyor configured to convey the second cassette to the third storage area through a second conveyance path different from a first conveyance path through which the first cassette is to be conveyed by the first conveyor. With this configuration, the first cassette and the second cassette can be conveyed individually through different paths.

(14) In the above-mentioned item (13), the first storage area may be positioned between the first conveyance path and the second conveyance path, the second storage area may be in proximity to a first portion of the first storage area, the first portion being close to the first conveyance path, and the third storage area may be in proximity to a second portion of the first storage area, the second portion being close to the second conveyance path. With this configuration, the first cassette and the second cassette can be conveyed through efficient paths, respectively.

(15) In the above-mentioned item (14), the drug packaging system may further include a casing that accommodates the first storage area, the second storage area, and the third storage area; the casing may include a first surface, a second surface, and a third surface; the first surface and the second surface may be two surfaces opposite to each other; the third surface may connect the first surface and the second surface to each other; the first conveyance path may be closer to the first surface than the first storage area; the second conveyance path may be closer to the second surface than the first storage area; and the third surface may include: a first transfer opening for receiving the first cassette conveyed through the first conveyance path; and a second transfer opening for receiving the second cassette conveyed through the second conveyance path. With this configuration, an operator can feed the first cassette and the second cassette to the drug packaging system from the third surface. Thus, efficient operation of the drug packaging system is enabled.

(16) A drug packaging system according to this embodiment includes: a storage cylinder having a columnar shape and being rotatable in a circumferential direction, the storage cylinder being for storing a plurality of cassettes containing drugs and for dispensing the drugs from the stored cassettes; a storage area, which is adjacent to the storage cylinder, and in which a plurality of cassettes are allowed to be stored; a conveyor configured to convey the cassette between the storage cylinder and the storage area; and a packaging unit configured to package the drugs dispensed from the cassette stored in the storage cylinder, in a packaging body. With this configuration, the cassette can be conveyed from the storage area to the storage cylinder, and further, the cassette stored in the storage cylinder can be moved by rotating the storage cylinder. Thus, the cassettes can be conveyed on a flexible schedule in order to efficiently package drugs.

Details of the embodiment of the present invention are described below with reference to the drawings. At least parts of the embodiment described below may be appropriately combined.

### 1. Entire Configuration of Drug Packaging System

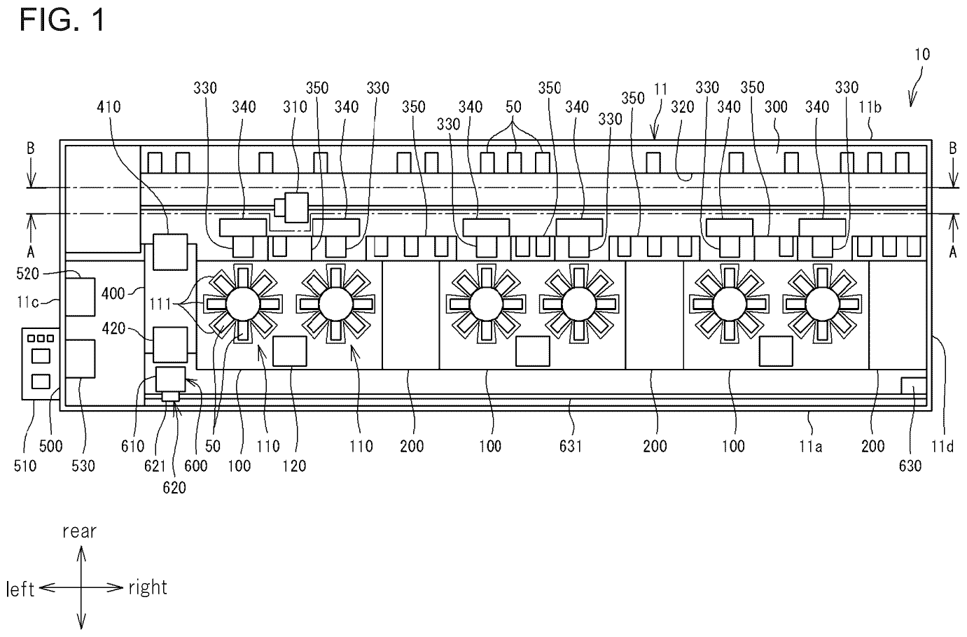

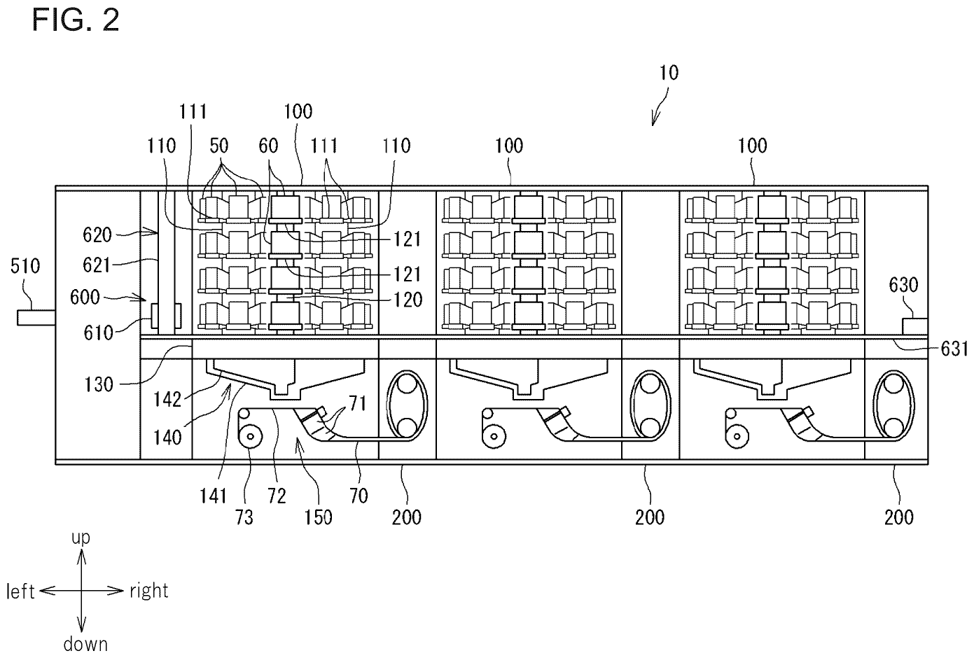

FIG. 1 is a plan view for illustrating an example of an entire configuration of a drug packaging system according to the embodiment. FIG. 2 is a front view thereof.

A drug packaging system 10 includes packaging devices 100 such as single- dose packaging devices, winding devices 200, a cassette storage device 300, a cassette distribution device 400, and an operation device 500.

The packaging device 100 dispenses drugs from a cassette 50, 60 containing the drugs, and packages the dispensed drugs in packaging bodies. The winding device 200 winds a package strip including a plurality of packaging bodies containing the drugs in a continuous manner.

The packaging device 100 can store a plurality of cassettes 50 and dispense drugs from the stored cassettes 50.

The same type of drugs are contained in one cassette 50. That is, the cassettes 50 are dedicated for specific types of drugs. The cassette 50 is one example of “first cassette”. In order to deal with a plurality of types of drugs, a plurality of cassettes 50 corresponding to the plurality of types of drugs are stored in the packaging device 100.

Further, the packaging device 100 can store a plurality of cassettes 60 and dispense drugs from the stored cassettes 60.

A drug selected from a plurality of types of drugs other than the types of drugs to be contained in the cassettes 50 is contained in one cassette 60. That is, the cassettes 60 can contain a plurality of types of drugs. Specifically, the cassettes 60 can adjust a size of a discharge path for the drugs. The cassette 60 can dispense drugs by adjusting the size of the discharge path in accordance with a size of the drug selected from the plurality of types of drugs. The cassette 60 is one example of “second cassette”. For example, a more frequently used drug is contained in the cassette 50, and a less frequently used drug is contained in the cassette 60.

A plurality of packaging devices 100 and a plurality of winding devices 200 are arranged in one row. The winding devices 200 correspond to the packaging devices 100 on a one-to-one basis. The packaging device 100 and the winding device 200 corresponding thereto are arranged adjacent to each other. That is, the packaging devices 100 and the winding devices 200 are arranged alternately in one row.

In the example of FIG. 1 and FIG. 2, the drug packaging system 10 including three packaging devices 100 and three winding devices 200 is illustrated. However, the number of packaging devices 100 and the number of winding devices 200 are not each limited to three. The drug packaging system 10 may include one packaging device 100 and one winding device 200, two packaging devices 100 and two winding devices 200, or four or more packaging devices 100 and four or more winding devices 200.

A direction in which the packaging devices 100 and the winding devices 200 are arranged is hereinafter referred to as “right-and-left direction” or “lateral direction”. A horizontal direction orthogonal to the right-and-left direction is referred to as “front-and-rear direction”. The terms “right-and-left direction”, “front-and-rear direction”, and “up-and-down direction” as used below are directions common to the whole drug packaging system 10, and are not directions individually defined for each unit.

As illustrated in FIG. 1, the cassette storage device 300 is arranged at the rear of the packaging devices 100 and the winding devices 200. The cassette storage device 300 can store the plurality of cassettes 50.

On the left of a leftmost one of the packaging devices 100, a refill station 450 is arranged. The refill station 450 includes the cassette distribution device 400 and the operation device 500.

The operation device 500 is used to allow an operator to operate the drug packaging system 10. The operation device 500 is arranged on the leftmost side in the drug packaging system 10. The operation device 500 includes an input device 510 that allows the operator to input information about drugs. The input device 510 includes, for example, a barcode reader, a radio frequency identification (RFID) reader, and a display. For example, drug containers containing drugs are supplied from a pharmaceutical company. The drug container has a barcode in which information about drugs contained in the drug container is recorded. The operator reads the barcode on the drug container with the use of the barcode reader. As a result, the information about the drug (including a drug ID) is input to the operation device 500. The cassette 50 has an RF tag. A cassette number for identifying the cassette 50 and a drug ID of drugs to be contained in the cassette are recorded in the RF tag. After putting the drug into the cassette 50, the operator reads the RF tag on the cassette 50 with the use of the RFID reader. The read drug ID and cassette number are displayed on the display, and thus the operator can check the cassette number and the drug ID.

Further, the operation device 500 includes a first transfer opening 520 for receiving the cassette 50. The first transfer opening 520 allows the cassette 50 to be placed therein, and is opened on a left side surface of the operation device 500. The first transfer opening 520 has a door, and has a table for placing the cassette 50 behind the door. The operator can place a new cassette 50 in the first transfer opening 520.

Further, the operation device 500 includes a second transfer opening 530 for receiving the cassette 60. The second transfer opening 530 allows the cassette 60 to be placed therein, and is opened on a left side surface of the operation device 500. The second transfer opening 530 has a door, and has a table for placing the cassette 60 behind the door. The operator can place a new cassette 60 in the second transfer opening 530.

As illustrated in FIG. 1, the drug packaging system 10 is entirely covered with a casing 11. The casing 11 includes a front surface 11a, a rear surface 11b, a left side surface 11c, and a right side surface 11d, each having a panel-like shape. The front surface 11a forms front surfaces of the packaging devices 100 and the winding devices 200. The rear surface 11b forms a rear surface of the cassette storage device 300. The left side surface 11c forms a left side surface of the operation device 500 (hereinafter also referred to as “operation surface”) and a left side surface of the cassette storage device 300. The right side surface 11d forms a right side surface of a rightmost one of the winding devices 200 and a right side surface of the cassette storage device 300. In FIG. 2, the illustration of a part of the front surface 11a is omitted.

The first transfer opening 520 and a second transfer opening 530 are opened on the operation surface 11c. The input device 510 is also provided on the operation surface 11c. With this arrangement, the operator can operate the drug packaging system 10 in a centralized manner on the operation surface 11c.

The cassette distribution device 400 can transfer the cassette 50 between the first transfer opening 520 and a first cassette transfer position 410. The first cassette transfer position 410 faces the cassette storage device 300. The first cassette transfer position 410 is a position for transfer of the cassette 50 between the cassette distribution device 400 and the cassette storage device 300.

The cassette storage device 300 includes a first conveyor 310. The first conveyor 310 conveys the cassettes 50 inside the cassette storage device 300. The cassette storage device 300 allows the first conveyor 310 to convey the cassette 50 received at the first cassette transfer position 410 and stores the cassette 50 in the cassette storage device 300. The cassette storage device 300 is one example of “second storage area”.

The cassette storage device 300 includes storage shelves 320 and 350 and cassette racks 330. The storage shelves 320 and 350 can store the plurality of cassettes 50. The plurality of cassette racks 330 are each adjacent to the packaging device 100 at the rear of the packaging device 100. The cassette racks 330 are provided so as to correspond to storage cylinders 110 described later, respectively. The cassettes 50 to be conveyed to the packaging device 100 are accommodated in the cassette racks 330. That is, the cassette racks 330 are each a preparatory area for preparation for the conveyance of the cassette 50 to the packaging device 100. The storage shelf 320 is one example of “first accommodating position”, and the cassette rack 330 is one example of “second accommodating position”. The storage shelf 320 may be provided not only at the rear of the cassette racks 330 and may also be additionally provided so as to be positioned in substantially the same vertical plane as a vertical plane of the cassette rack 330 (that is, so as to be adjacent to the cassette racks 330 in the right-and-left direction). As a result, the capacity for the cassettes 50 can be increased.

At the rear of each of the plurality of packaging devices 100, a plurality of cassette racks 330 are arranged at a given interval in a row in the right-and-left direction.

A plurality of storage shelves 350 are each arranged on the right and the left of each of the cassette racks 330 at the rear of the packaging devices 100. That is, the storage shelf 350 is arranged between the cassette racks 330 being adjacent to each other in the right-and-left direction. In other words, the cassette rack 330 is arranged between two storage shelves 350. For example, with respect to one cassette rack 330, the storage shelf 350 on the left side corresponds to “first storage”, and the storage shelf 350 on the right side corresponds to “second storage”.

The storage shelf 320 is arranged at a given distance away from the cassette racks 330 and the storage shelves 350 behind the cassette racks 330 and the storage shelves 350. The storage shelf 320 corresponds to “third storage”.

The first conveyor 310 conveys the cassettes 50 between the storage shelf 320 and each of the cassette racks 330 and the storage shelves 350. That is, a conveyance space for allowing the first conveyor 310 to convey the cassettes 50 is defined at the rear of the cassette racks 330 and the storage shelves 350. The storage shelf 320 is arranged at the rear of the conveyance space.

The cassette storage device 300 further includes second conveyors 340. The second conveyors 340 each convey the cassette 50 from the cassette rack 330 to the packaging device 100. The cassette 50 conveyed from the cassette rack 330 to the packaging device 100 is stored in the packaging device 100. The cassette racks 330 are respectively provided at six positions corresponding to the storage cylinders 110 described later.

A conveyance device 600 is arranged on a front side of the plurality of packaging devices 100. The conveyance device 600 can convey the cassettes 60. The conveyance device 600 is one example of “third conveyor”.

The cassette distribution device 400 can transfer the cassette 60 between the second transfer opening 530 and a second cassette transfer position 420. The second cassette transfer position 420 faces a left end portion of the conveyance device 600. The second cassette transfer position 420 is a position for transfer of the cassette 60 between the cassette distribution device 400 and the conveyance device 600.

The conveyance device 600 conveys the cassette 60 received at the second cassette transfer position 420 to one of the plurality of packaging devices 100. The conveyance device 600 is one example of “third conveyor”. The cassette 60 conveyed by the conveyance device 600 is stored in the packaging device 100.

### 2. Single-Dose Packaging Device

The packaging device 100 includes the storage cylinders 110 capable of storing a plurality of cassettes 50, each containing drugs (tablets) for each type. The storage cylinder 110 has a columnar shape and is formed so as to be rotatable in a circumferential direction. The storage cylinder 110 is a storage area for storing the cassettes 50. The storage cylinder 110 can dispense the drugs from the cassettes 50 stored therein. The storage cylinder 110 is one example of “first storage area”.

The storage cylinder 110 includes a plurality of cassette accommodating portions 111, each capable of accommodating the cassette 50. The plurality of cassette accommodating portions 111 are arranged in the circumferential direction of the storage cylinder 110 and the up-and-down direction. One cassette 50 is accommodated (held) in one cassette accommodating portion 111. A columnar body located in the center of the storage cylinder 110 is hollow, and its internal space serves as a passage for drugs. The cassette accommodating portion 111 includes a chute through which drugs dispensed from the cassette 50 pass. The chutes of the cassette accommodating portions 111 are in communication with the internal space of the storage cylinder 110. The drugs dispensed from the cassette 50 pass through the chute and the internal space, and drop down to a lower part of the packaging device 100. The drugs can be dispensed from the cassette 50 not only when the storage cylinder 110 is stationary but also while the storage cylinder 110 is rotating. In FIG. 1, for simplification of the illustration, the cassette accommodating portions 111 and the cassettes 50 are each illustrated as a rectangle in plan view. However, the cassette accommodating portion 111 and the cassette 50 each have a fan shape with a truncated tip. Details of the cassette accommodating portion 111 and the cassette 50 are described later.

In the example of FIG. 1 and FIG. 2, two storage cylinders 110 are provided in one packaging device 100. The two storage cylinders 110 are arranged side by side in the right-and-left direction inside the packaging device 100. However, the number of storage cylinders 110 included in the packaging device 100 is not limited to two. One storage cylinder 110, or three or more storage cylinders 110 may be provided in the packaging device 100. When a plurality of storage cylinders 110 are provided in the packaging device 100, the plurality of storage cylinders 110 are arranged side by side in one row in the right-and-left direction. The right-and-left direction is one example of “first direction”.

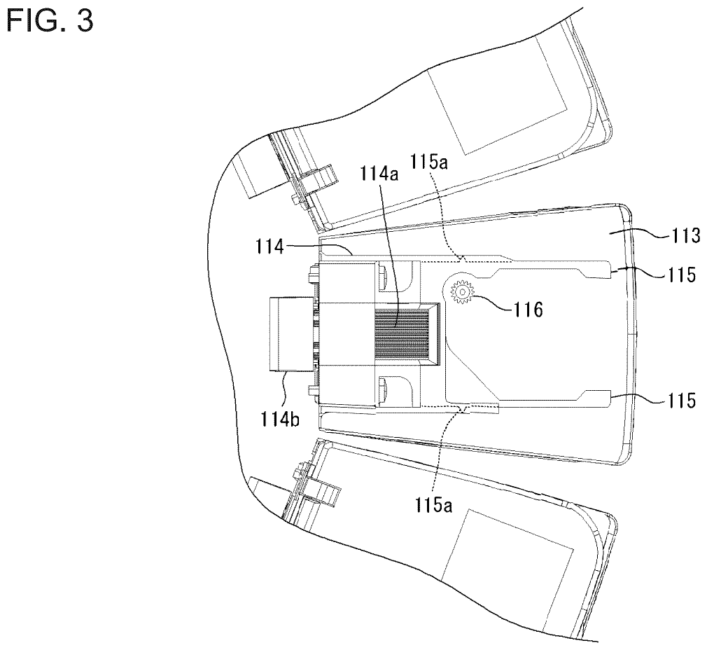

FIG. 3 is a plan view for illustrating an example of a configuration of the cassette accommodating portion in the embodiment. In the storage cylinder 110, a plurality of cassette accommodating portions 111 are arranged in an annular pattern. In the storage cylinder 110, a plurality of sets, each including the cassette accommodating portions 111 arranged in an annular pattern, are arranged in a plurality of layers in the up-and-down direction. In one layer, the plurality of cassette accommodating portions 111 are arranged on one plane. That is, in the storage cylinder 110, the plurality of cassette accommodating portions 111 are arranged in an annular pattern on each of a plurality of planes set in a vertical direction. The storage cylinder 110 is rotatable about a center axis of the annulus. That is, the set of cassette accommodating portions 111 in each of the layers is movable in an annular manner on a corresponding plane. One set of the cassette accommodating portions 111 arranged in an annular pattern corresponds to a “cassette holding portion”. Each of the cassette accommodating portions 111 is formed in a flat base-like shape and has an upper surface that allows placement of the cassette 50.

The cassette accommodating portion 111 includes a table 113 and a holding portion 114. The table 113 has a fan shape with a truncated tip in plan view. The holding portion 114 holds the cassette 50 placed on the table 113. The table 113 is a base on which the cassette 50 is to be placed. The holding portion 114 is provided on the tip side of the fan shape of the table 113.

The holding portion 114 has a feed port 114a through which drugs dispensed from the cassette 50 are fed. The feed port 114a is in communication with a chute 114b.

The cassette accommodating portion 111 includes lock portions 115 for locking holding of the cassette 50. The lock portions 115 are two arms extending from the holding portion 114 to a radially outer side of the fan shape. A projecting portion 115a is formed on an intermediate portion of each of the two lock portions 115 in a longitudinal direction. The projecting portion 115a on a right one of the lock portions 115 projects rightward, and the projecting portion 115a on a left one of the lock portions 115 projects leftward.

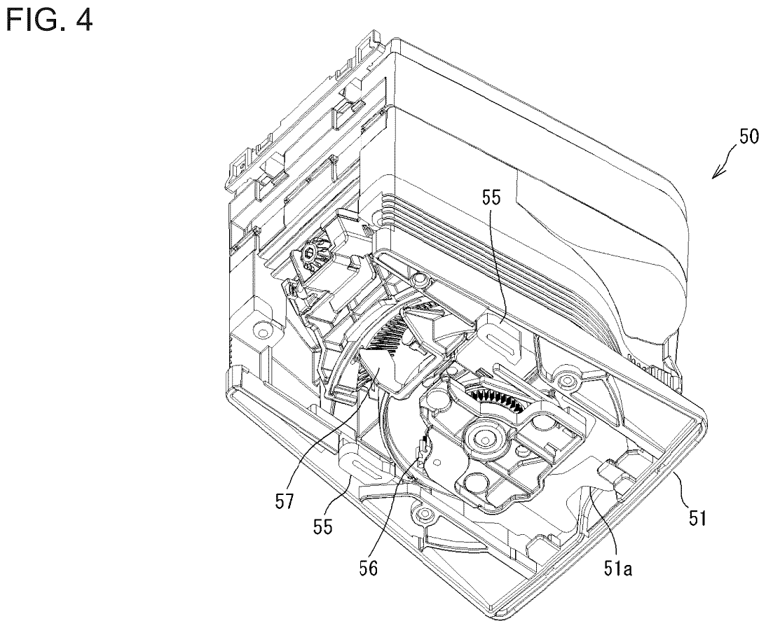

FIG. 4 is a perspective view for illustrating a bottom surface of the cassette in the embodiment. An outlet 57 for discharging drugs is opened on the bottom surface 51 of the cassette 50. Further, a pair of engaging portions 55 to be engaged with the lock portions 115 of the cassette accommodating portion 111 are provided on the bottom surface of the cassette 50. The engaging portions 55 are urged by springs (not shown) in directions of moving closer to each other, and are movable in directions of separating from each other.

When the cassette 50 is slid from an outer side toward an inner side of the table 113 (that is, in a direction from the outer side of the fan shape toward its center) in the cassette accommodating portion 111, the pair of lock portions 115 and the pair of engaging portions 55 are brought into contact with each other. More specifically, a left side surface of the right engaging portion is brought into contact with a right side surface of the right lock portion 115, and a right side surface of the left engaging portion is brought into contact with a left side surface of the left lock portion 115. When the cassette 50 is further slid on the table 113, the engaging portions 55 are brought into contact with the projecting portions 115a. Two engaging portions 55 are moved along the projecting portions 115a in the directions of separating from each other. After passing over the projecting portions 115a, the engaging portions 55 are returned to initial positions by urging forces. As a result, the lock portions 115 and the engaging portions 55 are engaged with each other to thereby lock the holding of the cassette 50.

A gear 56 is provided on the bottom surface side of the cassette 50. When the lock portions 115 and the engaging portions 55 are engaged with each other, the gear 56 is meshed with a gear 116 provided to the holding portion 114. When the gear 116 is driven by a motor (not shown), the gear 56 is rotated to operate a drug dispensing mechanism (not shown) built in the cassette 50. The drug dispensing mechanism dispenses a predetermined number of drugs from the outlet 57 each time, and the dispensed drugs are fed through the feed port 114a.

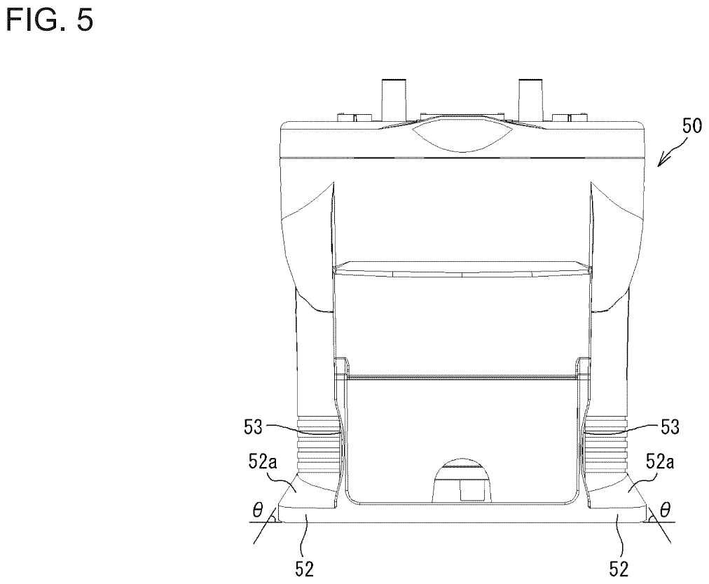

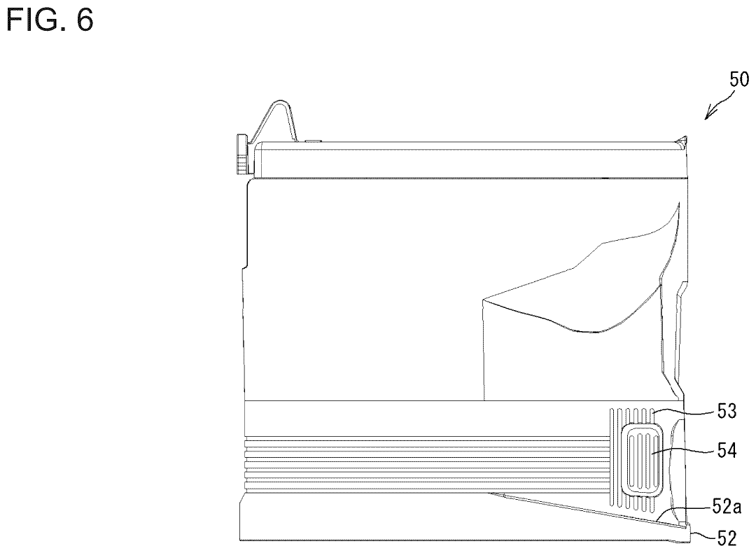

FIG. 5 is a front view of the cassette in the embodiment (as viewed from the outer side of the fan shape), and FIG. 6 is a side view thereof. A recessed portion 53 is formed in an intermediate portion of each of both side surfaces of the cassette 50 in the up-and-down direction so as to extend from an intermediate position in a radial direction to an outer edge. That is, an outer portion of the cassette 50 in the radial direction has a reduced width in the intermediate portion in the up-and-down direction. The recessed portions 53 are used by a user to grip the cassette 50.

Bottom portions of the cassette 50 below the recessed portions 53 protrude from both sides of the cassette 50. More specifically, protruding portions 52 that protrude laterally are formed below the recessed portions 53 described above. An outer edge shape of the pair of protruding portions 52 corresponds to an outer edge shape of a part of the cassette 50 above the recessed portions 53. That is, the outer edge of the protruding portions 52 forms a part of the fan shape with a truncated tip in plan view.

An upper surface of each of the protruding portions 52 is an inclined surface 52a being inclined so as to become lower toward the outer side. The protruding portions 52 form a part of the fan shape with a truncated tip in plan view. Thus, an outer edge shape of the inclined surface 52a is inclined (at an angle θ in FIG. 5) so as to become lower toward the outer side in front view, that is, as viewed in the radial direction of the fan shape toward the center thereof. That is, the outer edge of the inclined surface 52a in front view includes a straight line intersecting with a straight line extending toward the bottom surface of the cassette 50 at the angle θ.

Buttons 54 for unlocking the lock portions 115 are arranged in the recessed portions 53. The buttons 54 are operated in association with the engaging portions 55. When the buttons 54 are pushed, the pair of engaging portions 55 are moved in the directions of separating from each other. In this manner, the lock portions 115 and the engaging portions 55 are disengaged (unlocked) from each other.

Returning to FIG. 1, each of the packaging devices 100 includes a cassette storage unit 120. The cassette storage unit 120 is a storage area for storing a plurality of cassettes 60. The cassette storage unit 120 can dispense drugs from the stored cassettes 60. The cassette storage unit 120 is one example of “third storage area”.

The cassette storage unit 120 includes a plurality of cassette accommodating portions 121, each being capable of accommodating the cassette 60. The plurality of cassette accommodating portions 121 are arranged in the up-and-down direction. One cassette 60 is accommodated in one cassette accommodating portion 121.

The cassette storage unit 120 is positioned in a space defined by two storage cylinders 110 adjacent to each other. Specifically, two spaces, which are substantially triangular in plan view, are defined between two storage cylinders 110 adjacent to each other, each having a columnar shape. The cassette storage unit 120 is arranged in a front one of the two triangular spaces. In this manner, a storage capacity of the packaging device 100 for the cassettes 50 and 60 can be increased, while the packaging device 100 can be downsized.

As illustrated in FIG. 2, the packaging device 100 further includes a manual-dosing unit 130. The manual-dosing unit 130 is also referred to as “detachable tablet adapter (DTA)”. The manual-dosing unit 130 is used to dispense tablets being unsuitable for being dispensed from the cassettes 50 and 60, for example, a tablet less than a whole tablet, such as a ½ tablet or a ¼ tablet. The manual-dosing unit 130 is provided below the storage cylinders 110 and the cassette storage unit 120. The manual-dosing unit 130 is a drawer-like box body, inside which a plurality of slots that can accommodate drugs are provided in a grid-like pattern. When using the manual-dosing unit 130, the operator pulls out the manual-dosing unit 130, puts drugs into the slots, and then pushes the manual-dosing unit 130 back.

The packaging device 100 further includes a supply unit 140 and a packaging unit 150.

The supply unit 140 supplies drugs dispensed from the cassette 50 stored in the storage cylinder 110, drugs dispensed from the cassette 60 stored in the cassette storage unit 120, and drugs dispensed from the manual-dosing unit 130, to the packaging unit 150. The supply unit 140 includes a hopper 141 and a hopper 142. The hoppers 141 and 142 each have an inverted conical shape, an inverted triangular pyramid shape, an inverted quadrangular pyramid shape, or the like. The hopper 141 allows the drugs dispensed from the cassette 50 stored in the storage cylinder 110 and the drugs dispensed from the cassette 60 stored in the cassette storage unit 120, to be supplied to the packaging unit 150. The hopper 142 allows the drugs dispensed from the manual-dosing unit 130, to be supplied to the packaging unit 150.

The packaging unit 150 packages drugs supplied from the supply unit 140, into the packaging bodies 71. A package strip 70 includes a plurality of packaging bodies 71 being continuous in a band-like manner. The packaging body 71 has a bag shape and is to contain a drug therein. The packaging unit 150 holds a roll 73 of a sheet 72 before the package strip 70 is formed. The packaging unit 150 pulls out the sheet 72 from the roll 73 and bonds (thermally seals) a double-folded sheet 72 over the entire width at one position in a longitudinal direction to thereby form a bag-like pocket. A drug is dropped into the pocket below the supply unit 140. After that, the sheet 72 is bonded over the entire width and along a portion in the longitudinal direction (edge portion on the side opposite to the fold). In this manner, two open sides of the pocket are sealed to thereby form the packaging body 71 having a quadrangular shape.

The packaging unit 150 has an inspecting function for drugs before being packaged. Specifically, the packaging unit 150 includes a camera (not shown), and picks up an image of a drug before being dropped into the pocket, with the use of the camera. Whether or not a desired drug has been packaged is inspected by analyzing the image picked up by the camera.

The winding device 200 winds the package strip 70 moving from the packaging unit 150, into a roll. The package strip 70 wound by the winding device 200 is retrieved by the operator.

### 3. Cassette Storage Device

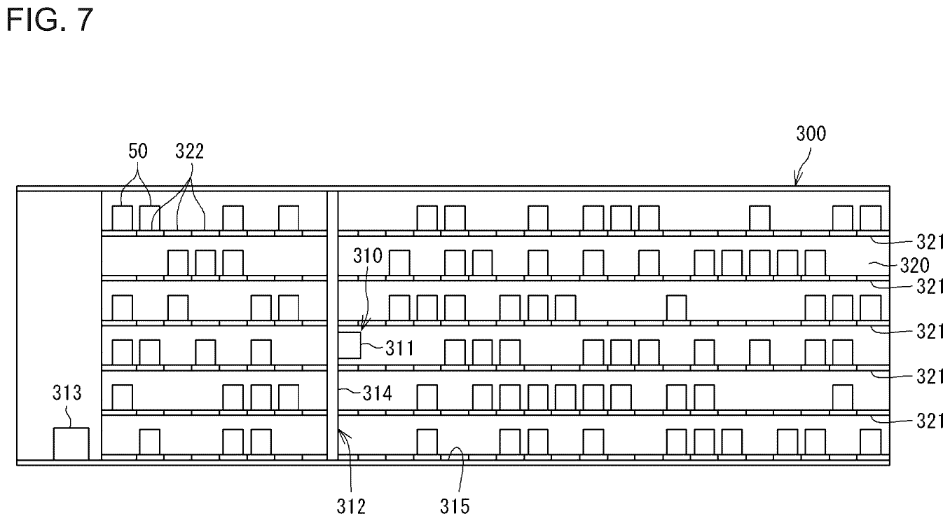

FIG. 7 is a view taken along the line A-A of FIG. 1 as viewed in the direction of arrows.

As illustrated in FIG. 7, the storage shelf 320 includes a plurality of shelf boards 321 arranged in the up-and-down direction. A plurality of accommodating portions 322 are arranged at given intervals in the right-and-left direction on each of the shelf boards 321. One accommodating portion 322 can accommodate one cassette 50. That is, a plurality of accommodating portions 322 are arranged in rows and columns in the storage shelf 320.

The first conveyor 310 is arranged in front of the storage shelf 320 (see FIG. 1). The first conveyor 310 includes a conveyance head 311, the vertically-moving unit 312, and a horizontal drive unit 313. The conveyance head 311 can hold the cassette 50 with a holding mechanism. The vertically-moving unit 312 includes a rail 314 extending in the up-and-down direction and a motor, and moves the conveyance head 311 in the up-and-down direction along the rail 314. The horizontal drive unit 313 includes a rail 315 extending in the right-and-left direction and a motor, and moves the conveyance head 311 and the vertically-moving unit 312 in the right-and-left direction along the rail 315. That is, the conveyance head 311 can be moved in the up-and-down direction and the right-and-left direction in front of the storage shelf 320.

The conveyance head 311 is configured so as to be rotatable by 180° in the horizontal direction by a motor. The conveyance head 311 can be rotated between a state of facing forward and a state of facing rearward.

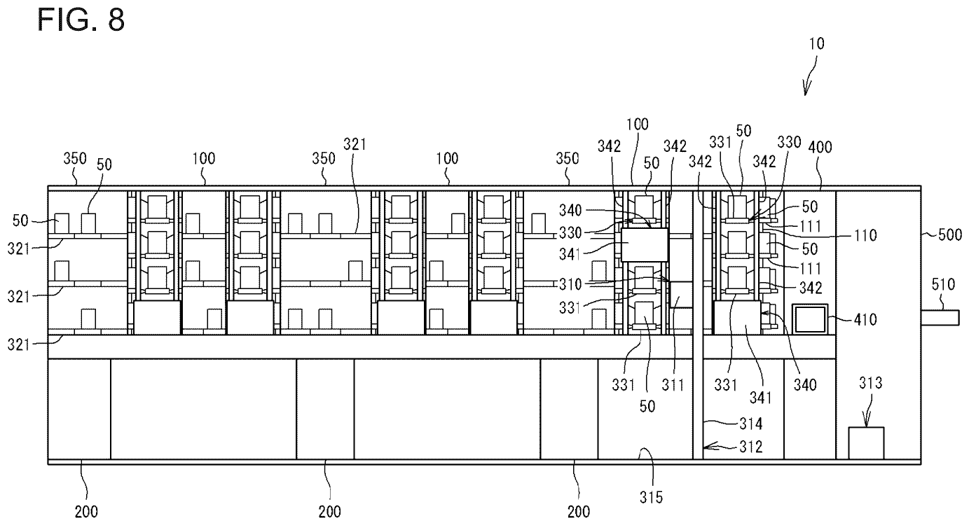

FIG. 8 is a view taken along the line B-B of FIG. 1 as viewed in the direction of arrows. The first conveyor 310 is arranged at the rear of the cassette distribution device 400, the packaging devices 100, the winding devices 200, and the storage shelves 350. That is, the first conveyor 310 is arranged between the packaging devices 100 and the storage shelf 320. In other words, the first conveyor 310 is arranged between the storage shelf 350 and the storage shelf 320.

The storage shelf 350 includes a plurality of shelf boards 321 arranged in the up-and-down direction, similarly to the storage shelf 320. A plurality of accommodating portions 322 are arranged at given intervals in the right-and-left direction on each of the shelf boards 321. A plurality of accommodating portions 322 are arranged in rows and columns in the storage shelf 350.

The first conveyor 310 moves the conveyance head 311 in the up-and-down direction, the right-and-left direction, or both of the directions to thereby position the conveyance head 311 at a position at which the conveyance head 311 is opposed to the first cassette transfer position 410. The conveyance head 311 holds the cassette 50 positioned at the first cassette transfer position 410, and pulls the cassette 50 rearward from the first cassette transfer position 410. In this manner, the first conveyor 310 can receive the cassette 50 from the cassette distribution device 400.

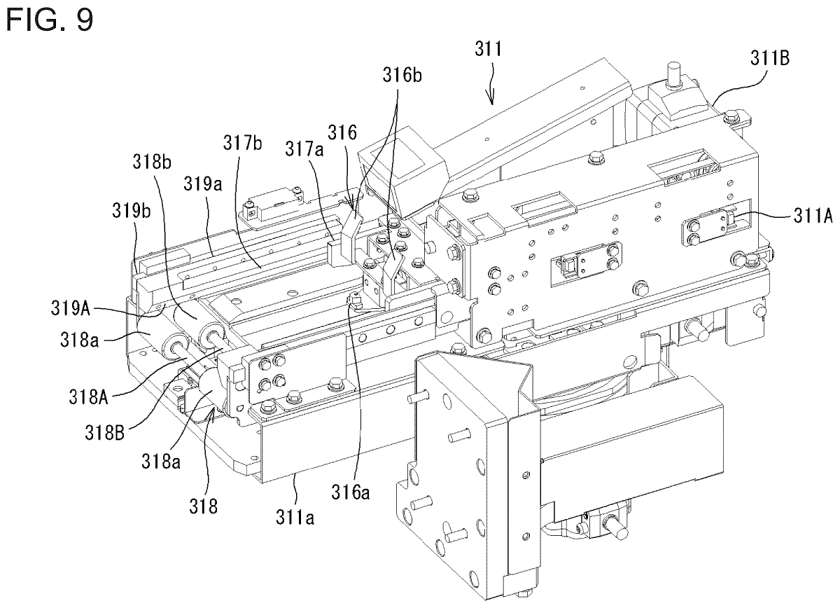

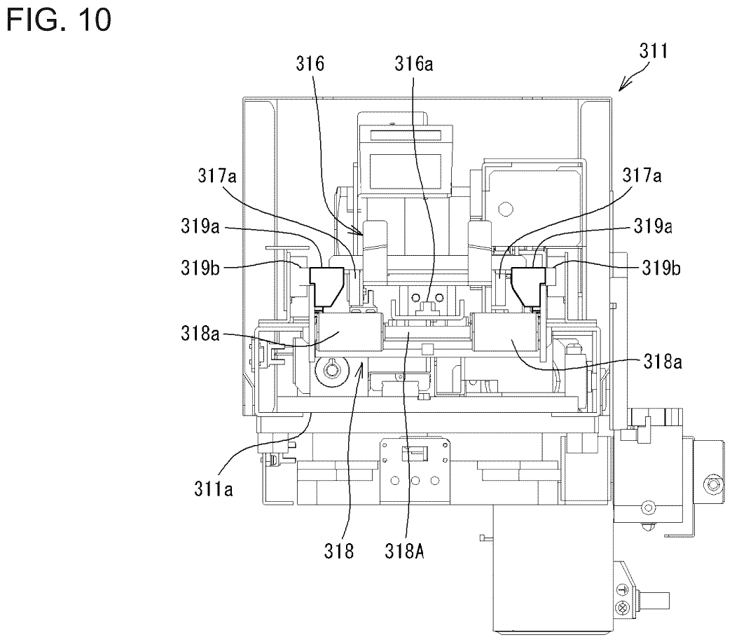

An example of a configuration of the conveyance head 311 is described further in detail. FIG. 9 is a perspective view for illustrating an example of the configuration of the conveyance head 311 in the embodiment, and FIG. 10 is a front view thereof.

The conveyance head 311 includes a base portion 311a, a contact portion 316, and a support portion 318.

The contact portion 316 and the support portion 318 are mounted on the base portion 311a.

The contact portion 316 can be moved in the longitudinal direction. When the conveyance head 311 moves the cassette 50 into and out from the storage shelf 320, the conveyance head 311 faces in a direction of being opposed to the storage shelf 320, that is, faces rearward. At this time, the contact portion 316 can be moved rearward and forward. When the conveyance head 311 moves the cassette 50 into or out from the storage shelves 350 or the cassette rack 330, the conveyance head 311 faces in a direction of being opposed to the storage shelf 320 or the cassette rack 330, that is, faces forward. At this time, the contact portion 316 can be moved forward and rearward. For simplification of the description, description is given below of a state in which the conveyance head 311 is facing forward.

The contact portion 316 is brought into contact with the cassette 50 and is used to hold the cassette 50. The contact portion 316 includes a projection 316a protruding upward and two holding plates 316b. The projection 316a is arranged at a distal end of the contact portion 316, and the holding plates 316b are arranged at the rear of the projection 316a.

As illustrated in FIG. 4, a recessed portion 51a is formed in the bottom surface 51 of the cassette 50. The recessed portion 51a is formed on a front side of the cassette 50, that is, in an outermost area of the fan shape. The projection 316a can be inserted into the recessed portion 51a. When the projection 316a is inserted into the recessed portion 51a, the holding plates 316b of the cassette 50 are brought into contact with a front surface of the cassette 50 or are positioned at the rear of the cassette 50 at a slight distance therefrom. When the cassette 50 is lifted up only by the contact portion 316 under a state in which the projection 316a is inserted in the recessed portion 51a, there is nothing that supports the bottom surface of the cassette 50, and a back surface side of the cassette 50 (that is, the tip side of the fan shape) moves down. At this time, the holding plates 316b are brought into contact with the front surface of the cassette 50. Thus, the cassette 50 is held by the projection 316a and the holding plates 316b, and hence does not fall off the conveyance head 311.

Returning to FIG. 9 and FIG. 10, the contact portion 316 includes carriages 317a for linear motion guide at both of right and left ends, respectively. A pair of rails 317b are provided on the support portion 318. The carriages 317a are engaged with the rails 317b, respectively, and are movable in the front-and-rear direction along the rails 317b. In this manner, the contact portion 316 is movable in the front-and-rear direction with respect to the support portion 318.

A motor 311A for moving the contact portion 316 is provided on the base portion 311a. Power of the motor 311A is transmitted to the contact portion 316, and thus the contact portion 316 is moved linearly along the rails 317b.

The support portion 318 is arranged below the contact portion 316. The support portion 318 can be moved forward and rearward.

The support portion 318 includes guide portions 319a, each including a carriage for linear motion guide, at both of the right and left ends, respectively. A pair of rails 319b are provided on the base portion 311a. The carriages of the guide portions 319a are engaged with the rails 319b and are movable in the front-and-rear direction along the rails 319b. In this manner, the support portion 318 is movable in the front-and-rear direction with respect to the base portion 311a. That is, the contact portion 316 and the support portion 318 are movable in the front-and-rear direction independently of each other.

The guide portions 319b are arranged apart from each other in the right-and-left direction. Each of the guide portions 319a extends in the front-and-rear direction. Lower parts of surfaces of two guide portions 319a, which are opposed to each other, are cut away. That is, the guide portion 319a is formed so that one corner of a square bar is chamfered entirely in the longitudinal direction. As a result, a retaining surface 319A being an inclined surface extends in the longitudinal direction. An inclination angle of the retaining surface 319A is an angle θ, which is the same as the angle θ (see FIG. 5) of each of the protruding portions 52 of the cassette 50 in front view.

A motor 311B for moving the support portion 318 is provided on the base portion 311a. Power of the motor 311B is transmitted to the support portion 318, and thus the support portion 318 is moved linearly along the rails 319b.

The support portion 318 has a pair of first rollers 318a and a pair of second rollers 318b at its distal end. The pair of first rollers 318a are mounted around a shaft 318A extending in the right-and-left direction so as to be arranged side by side in the right-and-left direction. Each of the first rollers 318a is rotatable about the shaft 318A. A shaft 318B extending in the right-and-left direction is arranged at the rear of the shaft 318A. The pair of second rollers 318b are mounted around the shaft 318B so as to be arranged side by side in the right-and-left direction. Each of the second rollers 318b is rotatable about the shaft 318B. The shafts 318A and 318B are arranged at the same height. The first rollers 318a and the second rollers 318b have the same radius.

The first rollers 318a and the second rollers 318b are used to support the cassette 50. When the first rollers 318a and the second rollers 318b are located on a front side of the projection 316a under a state in which the projection 316a is inserted in the recessed portion 51a of the cassette 50, the bottom surface of the cassette 50 is in contact with upper end points of the first rollers 318a and the second rollers 318b. When the contact portion 316 is moved in the front-and-rear direction relative to the support portion 318 under the above-mentioned state, the cassette 50 is moved on the first rollers 318a and the second rollers 318b. The first rollers 318a and the second rollers 318b are rotated along with the movement of the cassette 50.

The pair of guide portions 319a are spaced apart from each other by a distance corresponding to a maximum width of the cassette 50, specifically, a distance slightly larger than the maximum width of the cassette 50. Thus, the cassette 50 is movable on the support portion 318 in the front-and-rear direction between the guide portions 319a. Further, as described above, the guide portions 319a each have the retaining surface 319A. The angle θ of the retaining surface 319A corresponds to the angle θ of the bottom portion of the cassette 50. Thus, the guide portions 319a are engaged with the recessed portions 53 of the cassette 50, and the retaining surfaces 319A are positioned above the protruding portions 52 of the cassette 50. Thus, when the cassette 50 is moved on the support portion 318, upward movement of the cassette 50 is suppressed to thereby prevent the cassette 50 from falling off the support portion 318.

The first conveyor 310 rotates the conveyance head 311 holding the cassette 50 so that the conveyance head 311 faces rightward or leftward. The first conveyor 310 moves the conveyance head 311 being in the above-mentioned state, in the up-and-down direction, the right-and-left direction, or both of the directions. As illustrated in FIG. 7, the first conveyor 310 positions the conveyance head 311 at a position in front of one vacant accommodating portion 322 of the storage shelf 320, rotates the conveyance head 311 in the horizontal (front-and-rear) direction so that the conveyance head 311 faces rearward (in a direction closer to the rear surface 11b). The conveyance head 311 moves the cassette 50, which is being held thereby, rearward to thereby accommodate the cassette 50 in the accommodating portion 322. The conveyance head 311 releases the cassette 50 to thereby complete the transfer of the cassette 50 to the storage shelf 320.

The first conveyor 310 rotates the conveyance head 311 that has released the cassette 50 so that the conveyance head 311 faces rightward or leftward. Under this state, the first conveyor 310 can move the conveyance head 311 in the up-and-down direction and the right-and-left direction.

Further, the first conveyor 310 can pick up the cassette 50 from one accommodating portion 322 and convey the cassette 50 to the accommodating portion 322 located in a row, a column, or both of the row and the column, which are different from those in which the one accommodating portion 322 is located. That is, the first conveyor 310 moves the conveyance head 311 to a position at which the first conveyor 310 is opposed to one accommodating portion 322, and rotates the conveyance head 311 in the horizontal direction so that the conveyance head 311 faces rearward. The conveyance head 311 holds the cassette 50 accommodated in the accommodating portion 322 and pulls the cassette 50 forward from the accommodating portion 322.

The first conveyor 310 rotates the conveyance head 311 holding the cassette 50 so that the conveyance head 311 faces rightward or leftward. The first conveyor 310 moves the conveyance head 311 being in the above-mentioned state in the up-and-down direction, the right-and-left direction, or both of the directions. The first conveyor 310 positions the conveyance head 311 at a position in front of a target accommodating portion 322 (in a direction closer to the front surface 11a), rotates the conveyance head 311 in the horizontal direction so that the conveyance head 311 faces rearward. The conveyance head 311 moves the cassette 50, which is being held thereby, rearward to thereby accommodate the cassette 50 in the accommodating portion 322. The conveyance head 311 releases the cassette 50 to thereby complete the transfer of the cassette 50 inside the storage shelf 320.

FIG. 8 is now referred to. The cassette racks 330 each include a plurality of stands 331. The stand 331 is a plate-like member on which one cassette 50 can be placed. In one cassette rack 330, the same number of stands 331 as the number of layers in the storage cylinder 110 are arranged in the up-and-down direction. The stands 331 correspond to the layers in the storage cylinder 110, respectively. The stands 331 are arranged at the same heights as those of the corresponding layers in the storage cylinder 110.

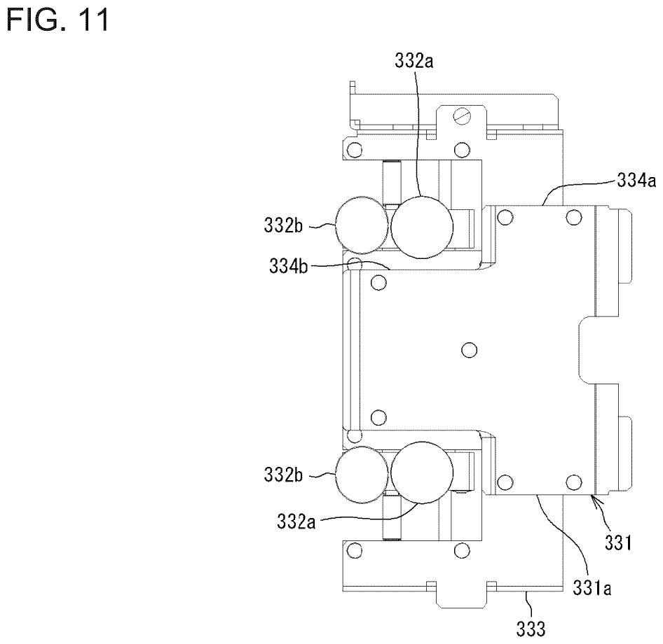

FIG. 11 is a plan view for illustrating an example of a configuration of the stand 331 in the embodiment. The stand 331 includes a main body portion 331a having a flat plate shape and a base portion 333. The main body portion 331a is arranged on the base portion 333, and is supported by the base portion 333.

The main body portion 331a has a T-like shape in plan view. That is, the main body portion 331a includes a first portion 334a corresponding to a larger width part of the T shape and a second portion 334b corresponding to a smaller width part of the T shape. In the main body portion 331a, the first portion 334a is positioned on a rear side, and the second portion 334b is positioned on a front side.

A width (length in the right-and-left direction) of the first portion 334a is larger than a width of the cassette 50. A width of the second portion 334b is smaller than the width of the cassette 50.

A pair of first rollers 332a and a pair of second rollers 332b are arranged on both sides of the second portion 334b. The first rollers 332a and the second rollers 332b are mounted to the base portion 333. The first rollers 332a are arranged at the rear of the second rollers 332b.

The pair of first rollers 332a are urged by springs in directions of moving closer to each other (right-and-left direction). That is, the pair of first rollers 332a are movable in directions of separating from each other. Under a natural state in which the pair of first rollers 332a are the closest to each other, the pair of first rollers 332a are separate from each other by a distance, which is larger than a width of a smallest width portion (portion closest to the center of the fan shape in the radial direction) of the cassette 50 having the fan shape with a truncated tip in plan view, and which is smaller than a width of a largest width portion (portion farthest from the center of the fan shape in the radial direction) of the cassette 50. The distance between the pair of first rollers 332a in this case refers to a distance between points on the two first rollers 332a, which are the closest to each other. The pair of first rollers 332a can be separated from each other by a distance equal to or larger than the width of the largest width portion of the cassette 50.

The pair of second rollers 332b are urged by springs in directions of moving closer to each other (right-and-left direction). That is, the pair of second rollers 332b are movable in directions of separating from each other. Under a natural state in which the pair of second rollers 332b are the closest to each other, the pair of second rollers 332b are separate from each other by a distance, which is larger than the width of the smallest width portion of the cassette 50 having the fan shape with a truncated tip in plan view, and which is smaller than the width of the largest width portion of the cassette 50. The distance between the pair of second rollers 332b in this case refers to a distance between points on the two second rollers 332b, which are the closest to each other. The pair of second rollers 332b can be separated from each other by a distance equal to or larger than the width of the largest width portion of the cassette 50.

The distance between the pair of second rollers 332b under the natural state is larger than the distance between the pair of first rollers 332a under the natural state.

When the cassette 50 placed on the stand 331 is to be conveyed to the table 113, the cassette 50 is slid from a front end of the main body portion 331a to the table 113. At this time, the cassette 50 is brought into contact with the first rollers 332a and the second rollers 332b. While the cassette 50 is passing between the first rollers 332a and between the second rollers 332b after the first rollers 332a and the second rollers 332b are brought into contact with both side surfaces of the cassette 50, the width of the cassette 50 causes the pair of first rollers 332a to separate apart from each other and causes the pair of second rollers 332b to separate apart from each other. As a result, the cassette 50 is conveyed without being inclined in the horizontal direction, and hence a center axis of the cassette 50 in the right-and-left direction is aligned with a center axis of the table 113 in the right-and-left direction.

As illustrated in FIG. 1, the second conveyors 340 correspond to the cassette racks 300 on a one-to-one basis. The second conveyor 340 is arranged at the rear of a corresponding one of the cassette racks 330.

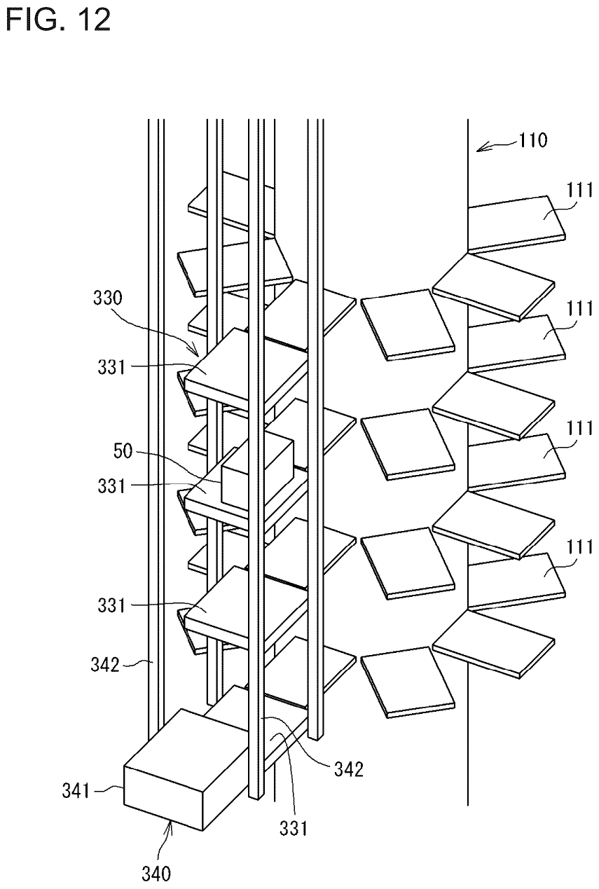

FIG. 12 is a perspective view for illustrating a positional relationship between the storage cylinder 110 and the second conveyor 340.

The second conveyor 340 includes a pushing mechanism 341 and rails 342. The rails 342 extend in the up-and-down direction at a position behind a corresponding one of the cassette racks 330. The pushing mechanism 341 includes a motor built therein, and is movable in the up-and-down direction along the rails 342.

The pushing mechanism 341 is moved upward or downward so as to be positioned at the rear of the stand 331 on which the cassette 50 is placed. Under this state, the pushing mechanism 341 moves the cassette 50 forward to thereby convey the cassette 50 from the stand 331 to the cassette accommodating portion 111.

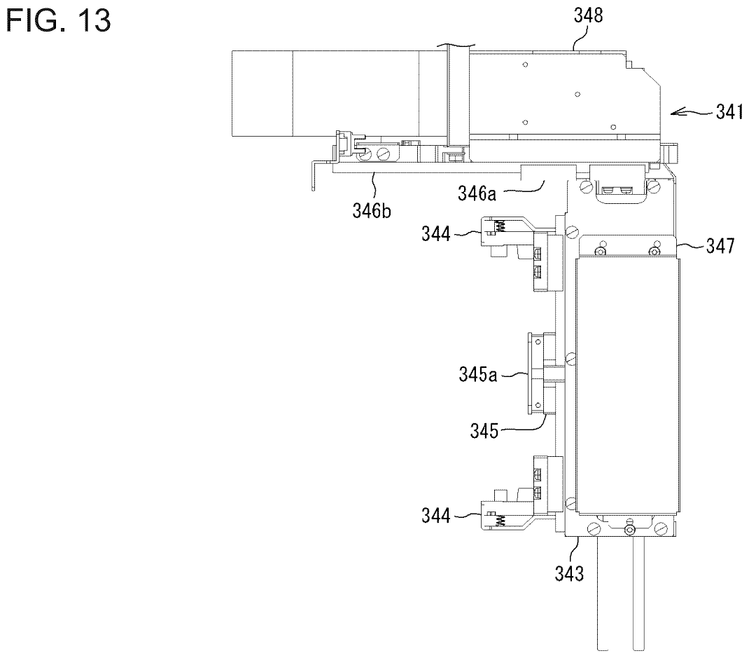

An example of a configuration of the pushing mechanism 341 is described further in detail. FIG. 13 is a plan view for illustrating an example of the configuration of the pushing mechanism 341 in the embodiment.

The pushing mechanism 341 includes a pushing member 347 and a base portion 348. The pushing member 347 is mounted on the base portion 348 so as to be movable in the front-and-rear direction. Specifically, the pushing member 347 includes a carriage 346a for linear motion guide at a left end. A rail 346b is provided to the base portion 348. The carriage 346a is engaged with the rail 346b, and is movable in the front-and-rear direction along the rail 346b. In this manner, the pushing member 347 is movable in the front-and-rear direction with respect to the base portion 348.

A motor for moving the pushing member 347 in the front-and-rear direction is provided to the base portion 348. Power of the motor is transmitted to the pushing member 347, and hence the pushing member 347 is moved in the front-and-rear direction along the rail 346b.

A catcher 344 including a pair of claw portions is provided on a front surface of the pushing member 341. The pair of claw portions of the catcher 344 are arranged apart from each other in the right-and-left direction on the front surface of the pushing member 341. The pair of claw portions can be moved in the right-and-left direction so as to be moved closer to and away from each other. A motor (not shown) is mounted on the pushing member 341. The claw portions are moved closer to or away from each other by power of the motor.

The catcher 344 is used to hold the cassette 50. That is, the catcher 344 holds the cassette 50 at the recessed portions 53 in both side surfaces in a pinching manner. Further, the catcher 344 is also used to push the buttons 54 provided in the recessed portions 53 of the cassette 50. That is, when the pair of claw portions are moved closer to each other, the claw portions are brought into contact with the buttons 54 to thereby push the buttons 54.

A contact portion 345 is provided between the pair of claw portions of the catcher 344 on the front surface of the pushing member 341. The contact portion 345 protrudes forward from the front surface of the pushing member 341, and has a contact surface 345a at a distal end. The contact surface 345a is a flat surface facing forward. The contact surface 345a is used to push out the cassette 50. That is, when the pushing member 341 is moved forward under a state in which the pair of claw portions are separated from each other in the right-and-left direction and the holding of the cassette 50 by the catcher 344 is cancelled, the contact surface 345a is brought into contact with a rear surface of the cassette 50. When the pushing member 341 is further moved forward, the cassette 50 is pushed forward.

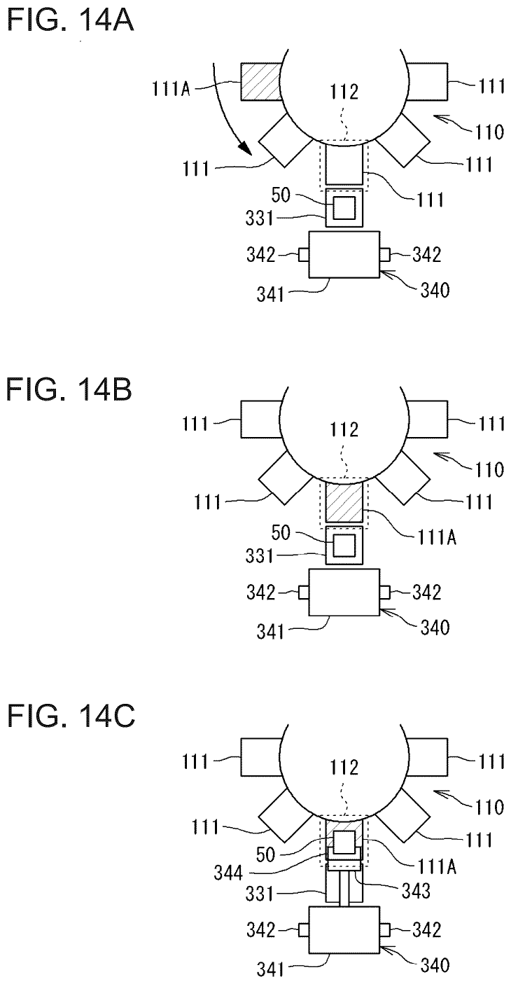

FIG. 14A to FIG. 14C are views for illustrating an example of conveyance of the cassette 50 by the second conveyor 340.

Among the plurality of cassette accommodating portions 111 arranged in the circumferential direction in the storage cylinder 110, a position of the cassette accommodating portion 111 opposed to the cassette rack 330 is a loading position 112. The loading position 112 is a position for loading and receiving the cassette 50 to and from the cassette accommodating portion 111. The second conveyor 340 can transfer the cassette 50 to the cassette accommodating portion 111 positioned at the loading position 112 and receive the cassette 50 from the cassette accommodating portion 111 positioned at the loading position 112.

The storage cylinder 110 can be rotated clockwise or counterclockwise by a motor. In FIG. 14A, the cassette accommodating portion 111 that is to accommodate the cassette 50 is referred to as “cassette accommodating portion 111A”, and is hatched. When the storage cylinder 110 is rotated in the circumferential direction (clockwise or counterclockwise), the cassette accommodating portion 111A is positioned at the loading position 112 (FIG. 14B).

The pushing mechanism 341 is moved upward or downward to be positioned in the layer in which the cassette accommodating portion 111A is located. The pushing mechanism 341 includes a pushing member 343 (FIG. 14C). The pushing mechanism 341 can move the pushing member 343 in the front-and-rear direction by means of a motor. Under an initial state, the pushing member 343 is positioned at the rear of the stand 331. The pushing mechanism 341 moves the pushing member 343 forward to thereby push the cassette 50 on the stand 331 forward. In this manner, the second conveyor 340 conveys the cassette 50 from the stand 331 to the cassette accommodating portion 111A located at the loading position 112.

The cassette storage device 300 can pick up the cassette 50 stored in the packaging device 100 and convey the cassette 50 that has been picked up to the storage shelf 320. For example, when the cassettes 50 stored in the storage cylinder 110 include a cassette 50 required to be refilled with drugs because of, for example, stockout occurring as a result of dispensing of all the drugs, or a cassette 50 to be removed because, for example, the cassette 50 remains therein without being used for a predetermined period of time, the storage cylinder 110 is rotated in the circumferential direction to position the cassette accommodating portion 111 that is accommodating an unrequired cassette 50 at the loading position 112.

The pushing mechanism 341 is moved upward or downward so as to be positioned in the layer in which the cassette accommodating portion 111 accommodating the unrequired cassette 50 is located. The pushing mechanism 341 includes the catcher 344 capable of holding the cassette 50 in a pinching manner. The catcher 344 is movable in the front-and-rear direction together with the pushing member 343. The pushing mechanism 341 moves the catcher 344 forward so that the catcher 344 holds the unrequired cassette 50 by pinching. The pushing mechanism 341 moves the catcher 344 holding the cassette 50 rearward, to transfer the cassette 50 onto the stand 331. The catcher 344 cancels the holding of the cassette, and then the pushing mechanism 341 is moved upward or downward.

The first conveyor 310 moves the conveyance head 311 in the up-and-down direction, the right-and-left direction, or both of the directions to position the conveyance head 311 at a position at which the first conveyor 310 is opposed to the stand 331 on which the unrequired cassette 50 is placed. The conveyance head 311 holds the cassette 50 placed on the stand 331, and then pulls the cassette 50 rearward from the stand 331.

The first conveyor 310 rotates the conveyance head 311 holding the cassette 50 so that the conveyance head 311 faces rightward or leftward. The first conveyor 310 moves the conveyance head 311 being in the above-mentioned state, in the up-and-down direction, the right-and-left direction, or both of the directions. As illustrated in FIG. 7, the first conveyor 310 positions the conveyance head 311 at a position in front of one vacant accommodating portion 322 of the storage shelf 320, 350, rotates the conveyance head 311 in the horizontal direction so that the conveyance head 311 faces rearward or forward. The conveyance head 311 moves the cassette 50, which is being held thereby, rearward or forward to thereby accommodate the cassette 50 in the accommodating portion 322. The conveyance head 311 releases the cassette 50 to thereby complete the transfer of the cassette 50 to the storage shelf 320 or 350.

When the cassette 50 stored in the storage shelf 320, 350 is to be picked up from the drug packaging system 10, the first conveyor 310 moves the conveyance head 311 to a position at which the conveyance head 311 is opposed to the accommodating portion 322 in which the cassette 50 to be picked up is accommodated, and then rotates the conveyance head 311 in the horizontal direction so that the conveyance head 311 faces rearward or forward. The conveyance head 311 holds the cassette 50 accommodated in the accommodating portion 322, and pulls the cassette 50 forward or rearward from the accommodating portion 322.

The first conveyor 310 rotates the conveyance head 311 holding the cassette 50 so that the conveyance head 311 faces rightward or leftward. The first conveyor 310 moves the conveyance head 311 being in this state, in the up-and-down direction, the right-and-left direction, or both of the directions. The first conveyor 310 positions the conveyance head 311 at a position at which the conveyance head 311 is opposed to the first cassette transfer position 410, and rotates the conveyance head 311 in the horizontal direction so that the conveyance head 311 faces forward. The conveyance head 311 moves the cassette 50, which is being held thereby, forward to thereby position the cassette 50 at the first cassette transfer position 410. The conveyance head 311 releases the cassette 50 to thereby complete the transfer of the cassette 50 to the first cassette transfer position 410.

The cassette distribution device 400 transfers the cassette 50 placed at the first cassette transfer position 410 to the first transfer opening 520. The operator can pick up the cassette 50 from the first transfer opening 520. After authentication check is performed for the cassette 50 that has been picked up, drugs (tablets) are refilled (the inventory is updated), and the cassette 50 is returned again to the first transfer opening 520. Then, the cassette 50 is accommodated in the storage cylinder 110 or the cassette storage device 300 in the above-mentioned manner.

### 4. Operation of Conveyance Head

An operation of the conveyance head 311 is described in detail. First, an operation in which the conveyance head 311 conveys the cassette 50 to the cassette rack 330 (stand 331) (hereinafter also referred to as “first carry-in operation”) is described.

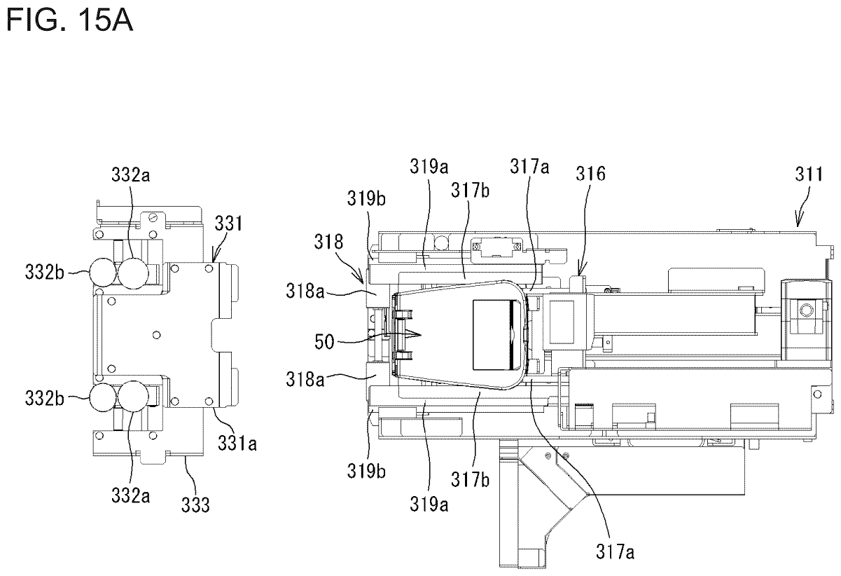

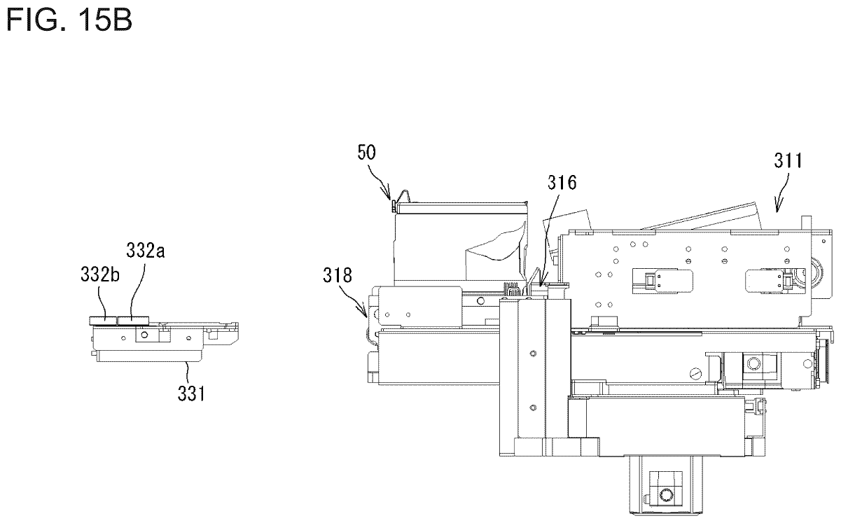

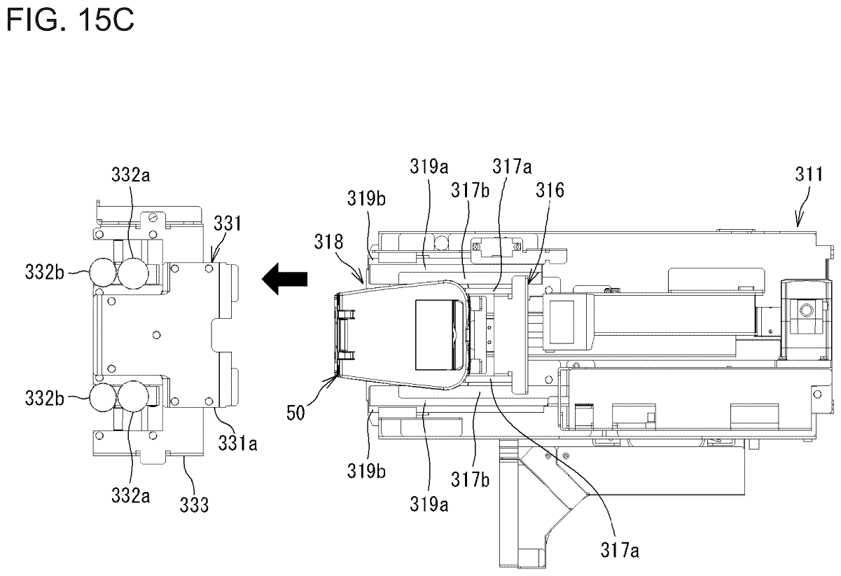

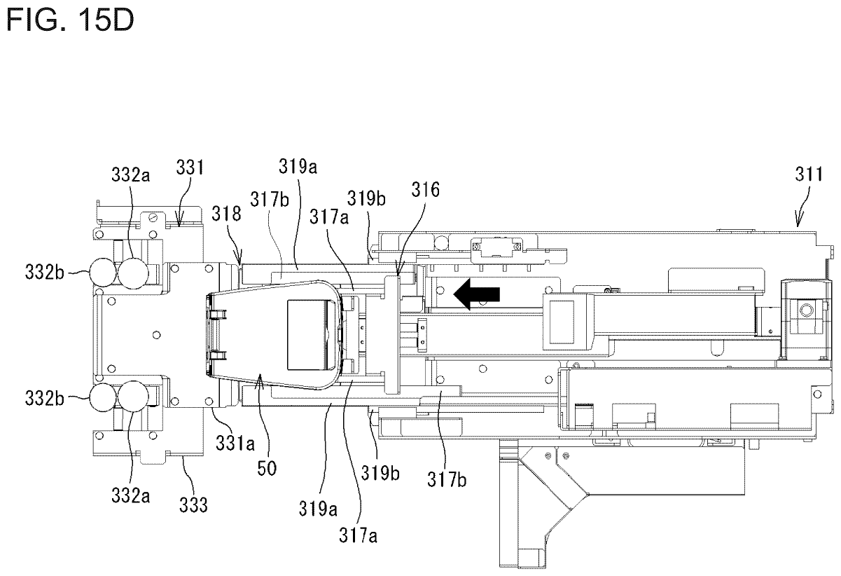

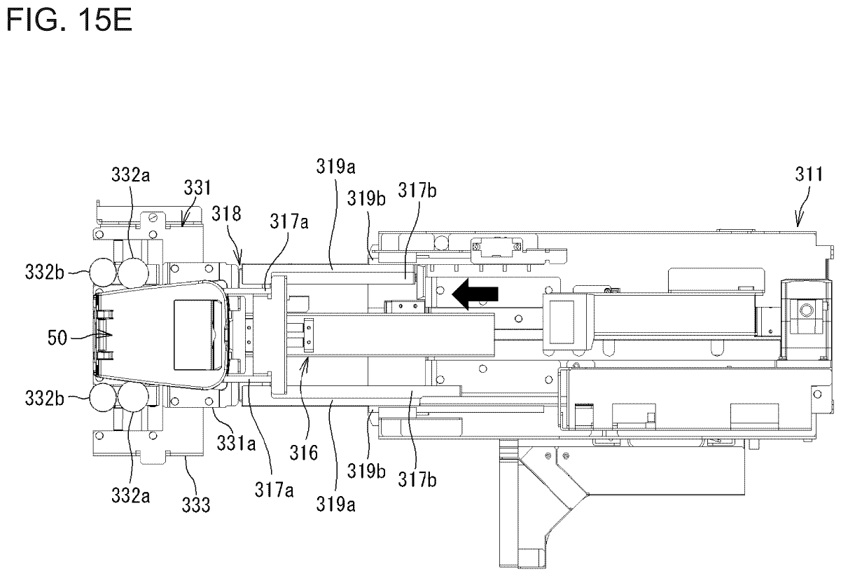

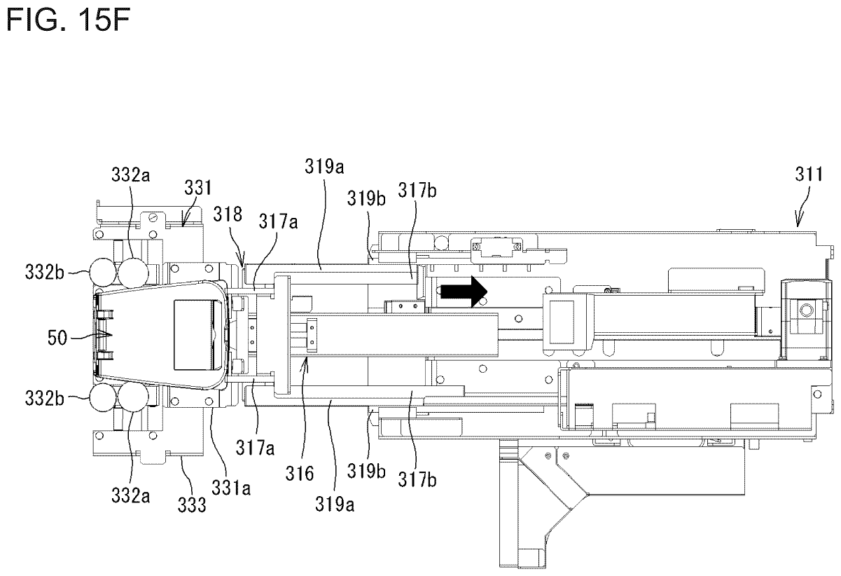

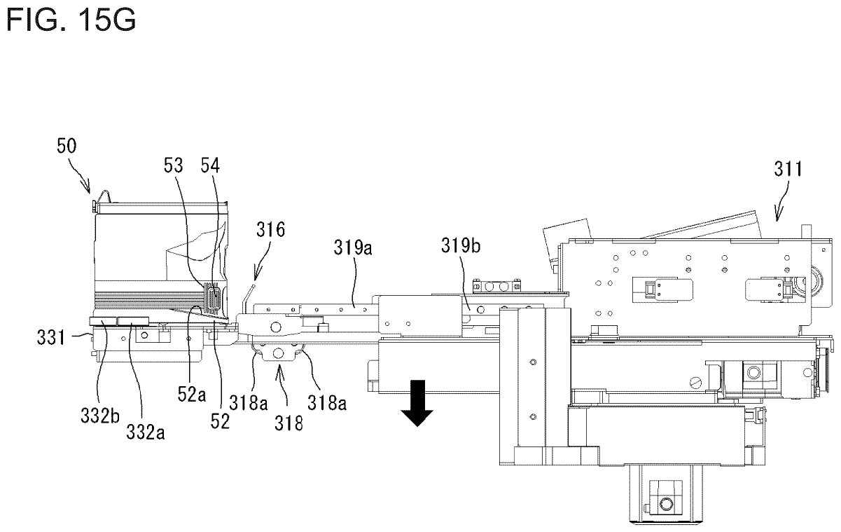

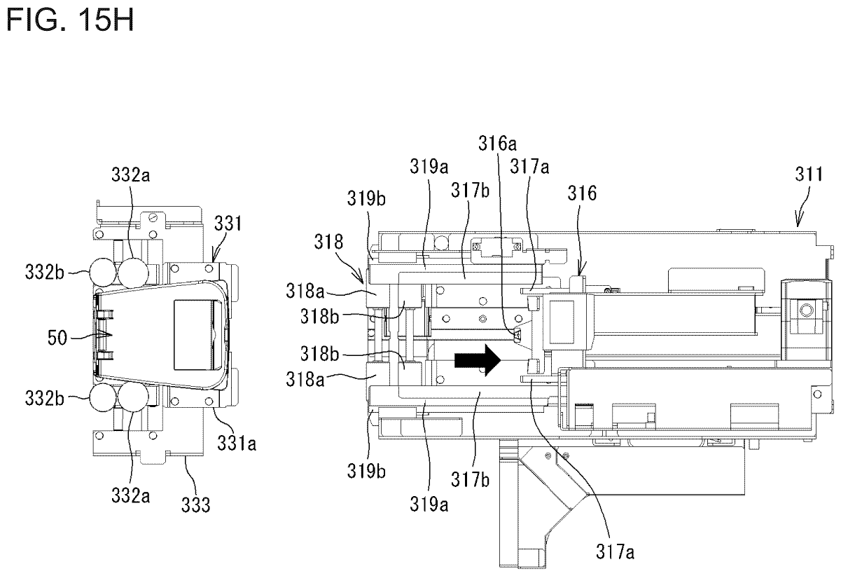

FIG. 15A to FIG. 15H are explanatory views for illustrating the first carry-in operation.

As illustrated in FIG. 15A and FIG. 15B, the cassette 50 picked up by the first conveyor 310 from the storage shelf 320, 350 is placed on the conveyance head 311. At this time, the projection 316a is inserted in the recessed portion 51a of the cassette 50. Under the state illustrated in FIG. 15A and FIG. 15B, the contact portion 316 and the support portion 318 of the conveyance head 311 are positioned at rearmost positions within a movable range. This state of the conveyance head 311 is referred to as “first reference state”. The conveyance head 311 holding the cassette 50 is moved to a position at which the conveyance head 311 is opposed to a target stand 331, that is, a position at a specified distance behind the target stand 331.

As illustrated in FIG. 15C, the contact portion 316 is moved forward by a predetermined first distance. The cassette 50 is moved on the support portion 318, and thus a distal end portion of the cassette 50 projects forward beyond the support portion 318.

As illustrated in FIG. 15D, the contact portion 316 and the support portion 318 are both moved forward by a second distance. As a result, a front end of the support portion 318 is moved closer to a rear end of the stand 331, and the cassette 50 is placed on a rear end portion of the main body portion 331a of the stand 331.

As illustrated in FIG. 15E, the contact portion 316 is moved forward by a third distance. As a result, the cassette 50 is slid forward on the main body portion 331a. Both side surfaces of the cassette 50 are brought into contact with the first rollers 332a, and thus the pair of first rollers 332a are separated apart from each other along the side surfaces of the cassette 50. The pair of first rollers 332a are urged in directions of moving closer to each other. Thus, the cassette 50 is pushed on both of the right and left sides to align the center axis of the cassette 50 in the width direction with a center axis of the main body portion 331a in the width direction.

As illustrated in FIG. 15F, the contact portion 316 and the support portion 318 are moved rearward by a fourth distance. The fourth distance is such a small distance that the projection 316a is allowed to be moved rearward inside the recessed portion 51a.

As illustrated in FIG. 15G, the conveyance head 311 is moved downward by a fifth distance. As a result, the projection 316a is removed from the recessed portion 51a to thereby cancel the holding of the cassette 50 by the conveyance head 311.

As illustrated in FIG. 15H, the contact portion 316 and the support portion 318 are moved rearward to bring the conveyance head 311 into the first reference state. The first carry-in operation is completed as described above.

Next, an operation in which the conveyance head 311 picks up the cassette 50 from the cassette rack 330 (stand 331) (hereinafter also referred to as “first carry-out operation”) is described.

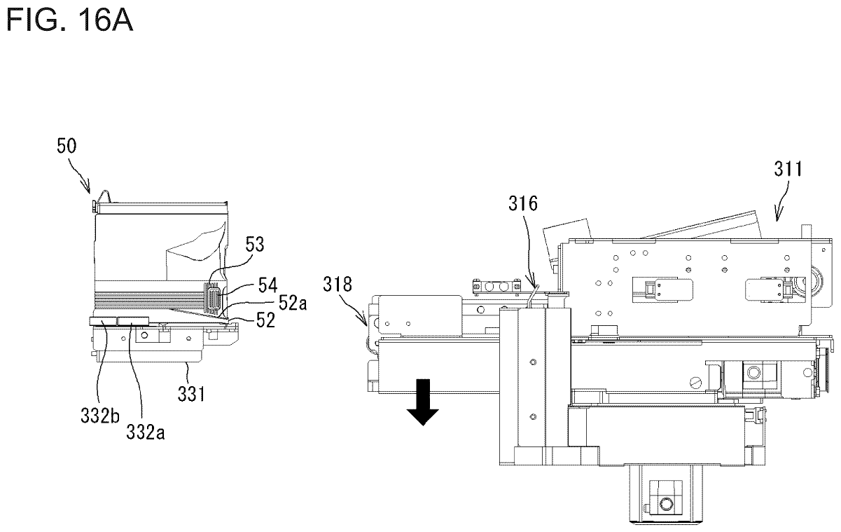

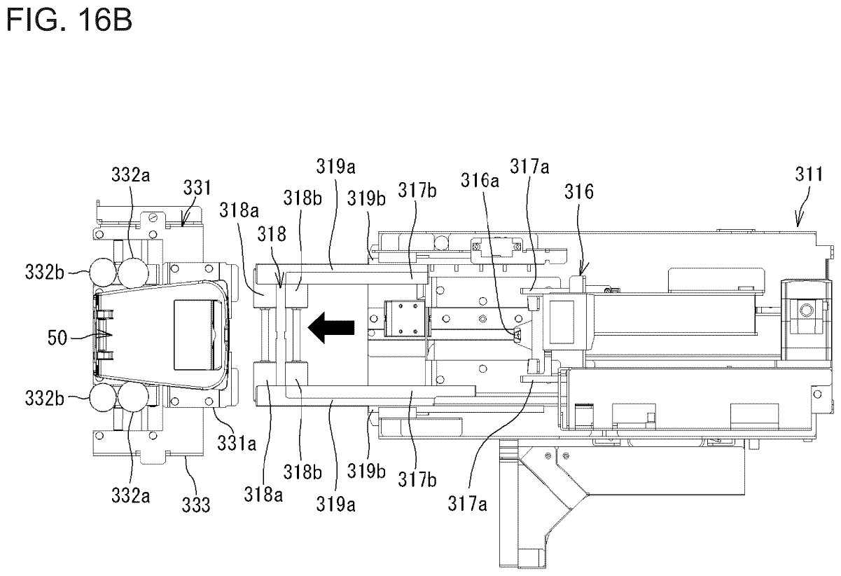

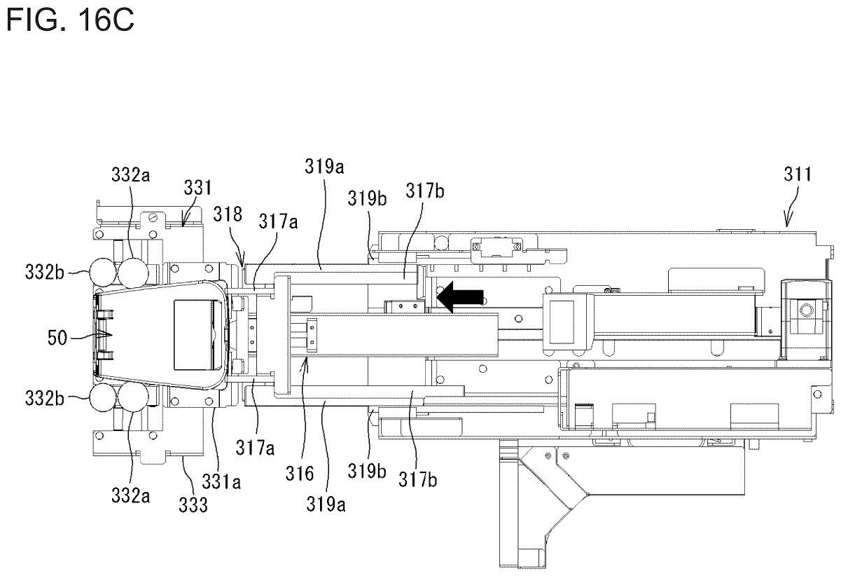

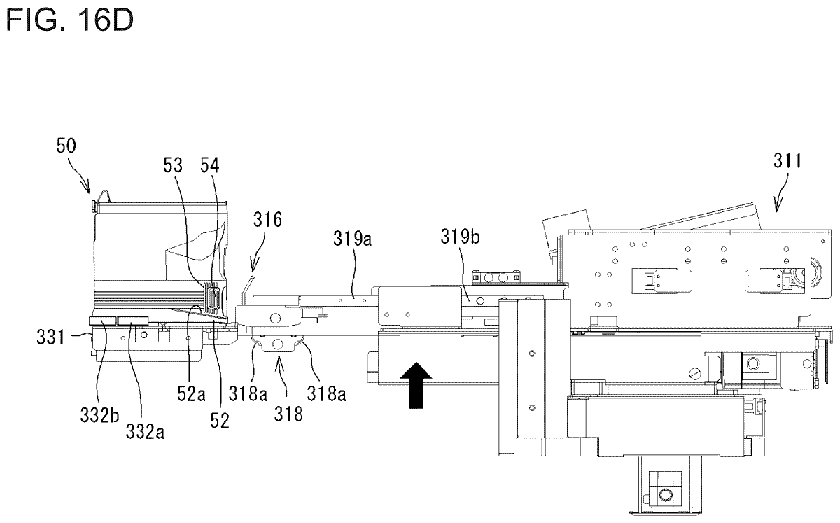

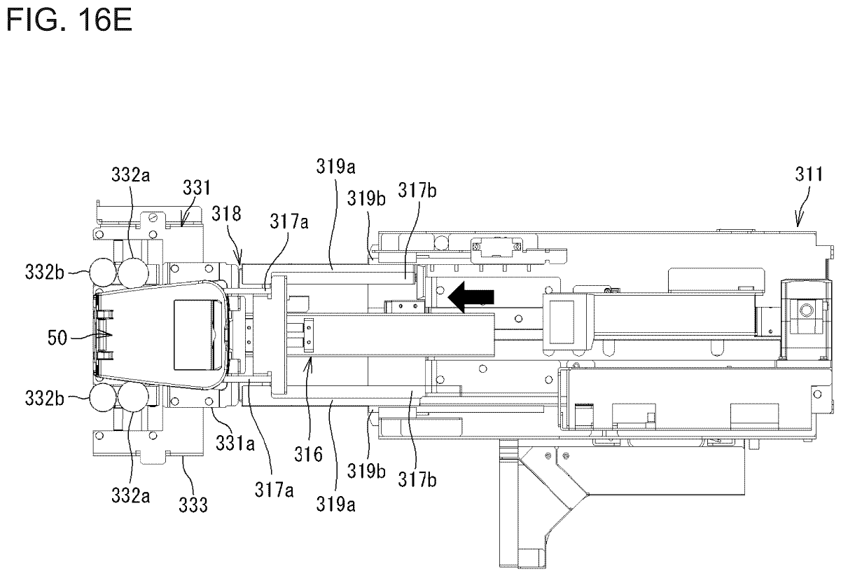

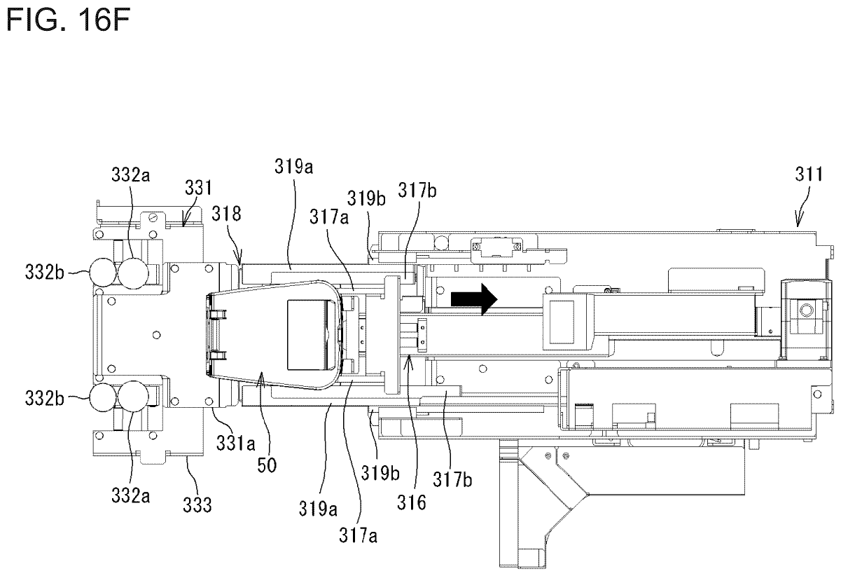

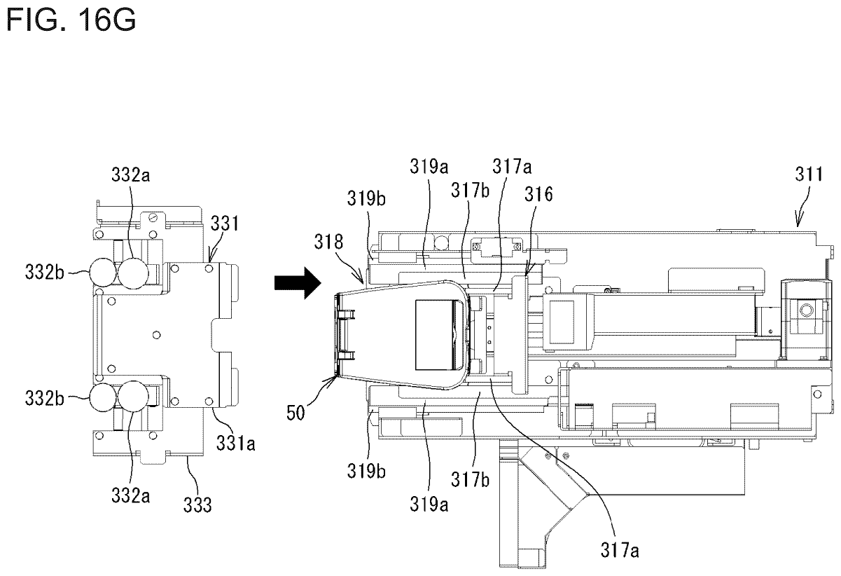

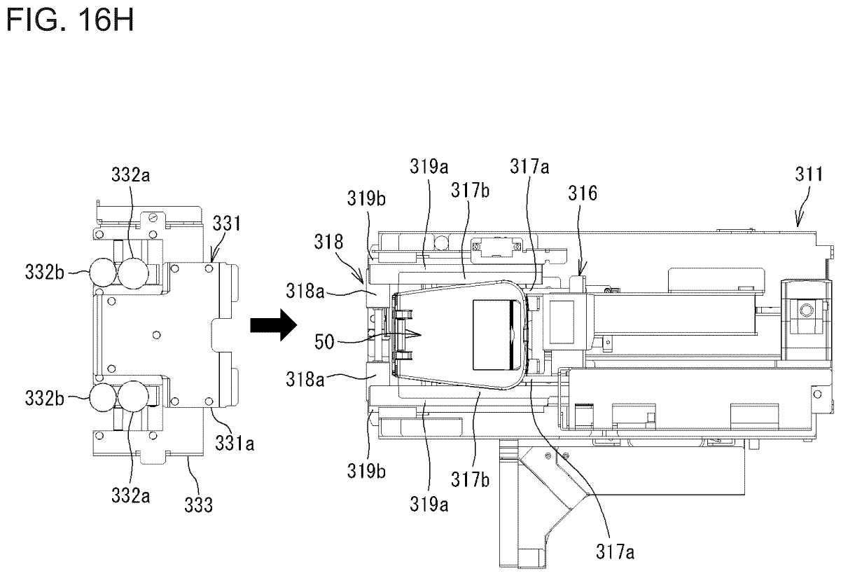

FIG. 16A to FIG. 16H are explanatory views for illustrating the first carry-out operation.

As illustrated in FIG. 16A, the cassette 50 is placed on the stand 331. The conveyance head 311 that is not holding the cassette 50 is moved to a position at a specified distance behind the target stand 331. At this time, the conveyance head 311 is in the first reference state.

The conveyance head 311 is moved downward by a sixth distance. As a result, the projection 316a is positioned below the bottom surface of the cassette 50 that is placed on the stand 331.

As illustrated in FIG. 16B, the support portion 318 is moved forward by a seventh distance. The distal end of the support portion 318 is brought closer to the rear end of the target stand 331 in the front-and-rear direction.

As illustrated in FIG. 16C, the contact portion 316 is moved forward by an eighth distance. The eighth distance is larger than the seventh distance. As a result, the projection 316a is positioned below the recessed portion 51a.

As illustrated in FIG. 16D, the conveyance head 311 is moved upward by the sixth distance. As a result, a height of the support portion 318 matches a height of the stand 331. The projection 316a is inserted into the recessed portion 51a.

As illustrated in FIG. 16E, the contact portion 316 and the support portion 318 are moved forward by a ninth distance. The ninth distance is such a small distance that the projection 316a is allowed to be moved forward inside the recessed portion 51a. As a result, the distal end of the support portion 318 is further brought closer to the rear end of the stand 331.

As illustrated in FIG. 16F, the contact portion 316 is moved rearward by a tenth distance. As a result, the cassette 50 is slid rearward on the main body portion 331a. During a process of this operation, the pair of the first rollers 332a are moved closer to each other along the side surfaces of the cassette 50, and then the cassette 50 is separated away from the pair of the first rollers 332a. A rear portion of the cassette 50 is pulled to an outside of the main body portion 331a, and a front end portion of the cassette 50 is brought into a state of being placed on the rear end portion of the main body portion 331a.

As illustrated in FIG. 16G, the contact portion 316 and the support portion 318 are moved rearward by an eleventh distance. The support portion 318 reaches the rearmost position within the movable range. The cassette 50 is moved rearward together with the contact portion 316 and the support portion 318. The distal end portion of the cassette 50 protrudes forward beyond the support portion 318.

As illustrated in FIG. 16H, the contact portion 316 is moved rearward by a twelfth distance. The cassette 50 is moved rearward on the support portion 318 so that the entirety of the cassette 50 is placed on the support portion 318. Through this operation, the conveyance head 311 is returned back into the first reference state. As described above, the first carry-out operation is completed.

### 5. Operation of Pushing Mechanism

An operation of the pushing mechanism 341 is described in detail. First, an operation in which the pushing mechanism 341 conveys the cassette 50 from the cassette rack 330 (stand 331) to the cassette accommodating portion 111 of the storage cylinder 110 (hereinafter also referred to as “second carry-in operation”) is described.

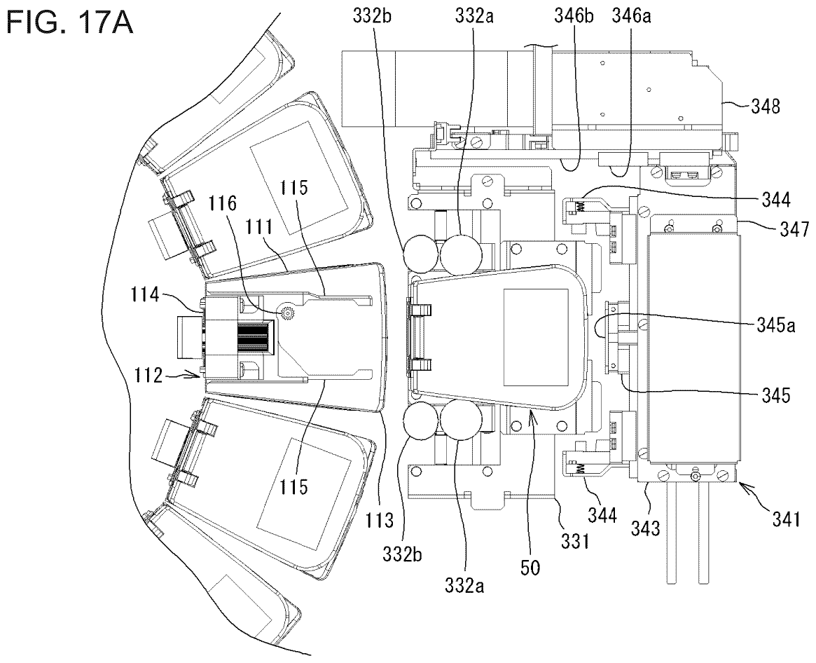

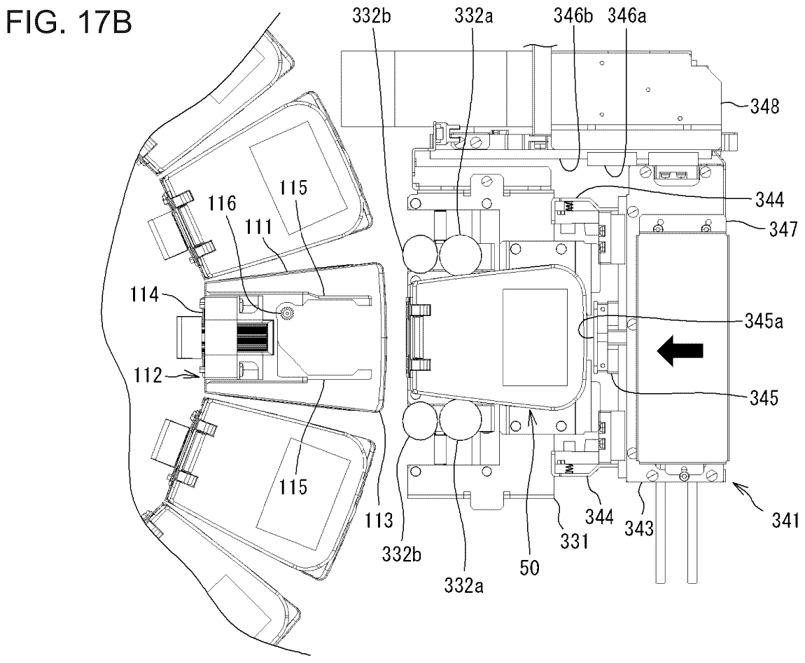

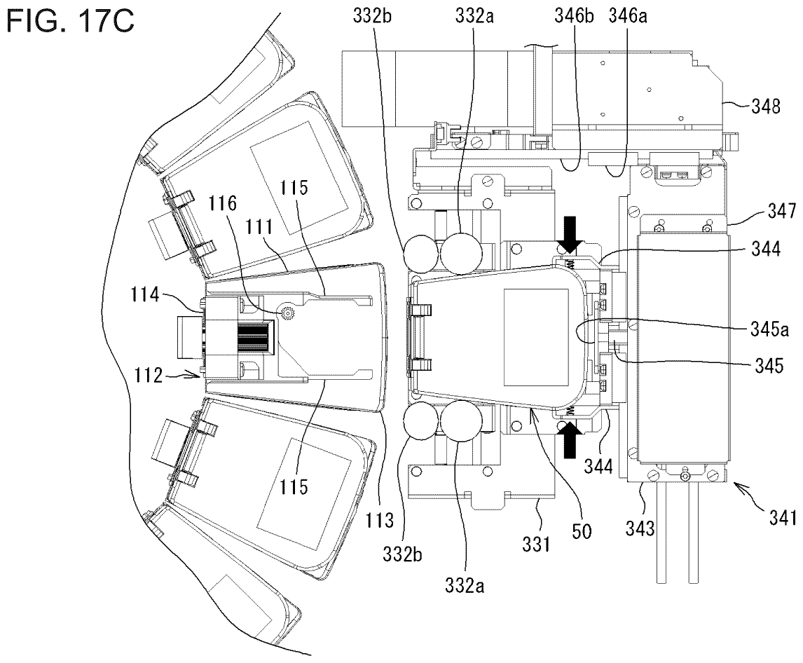

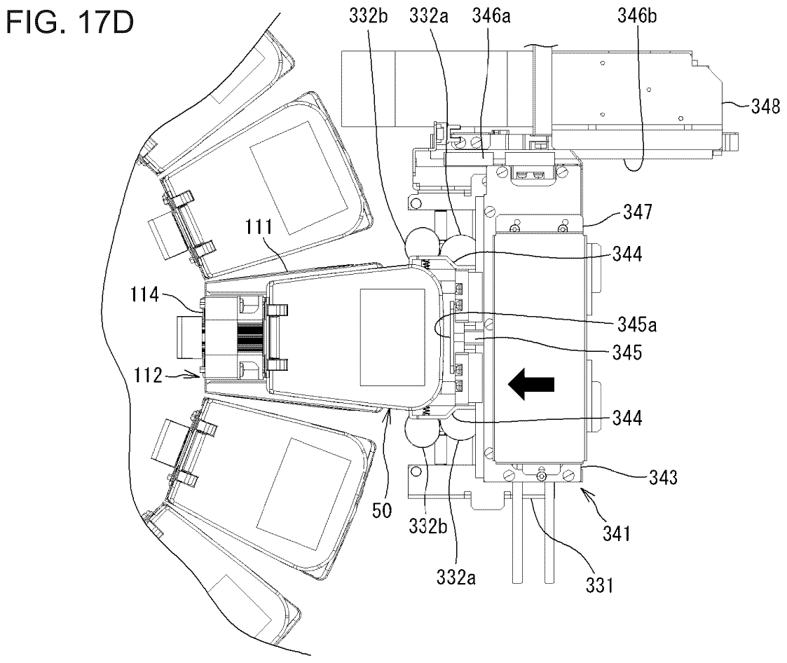

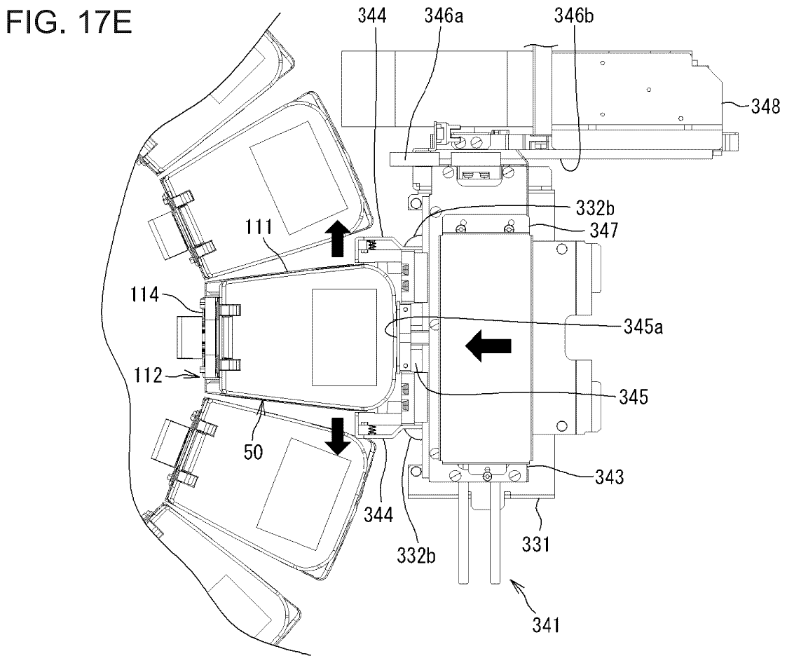

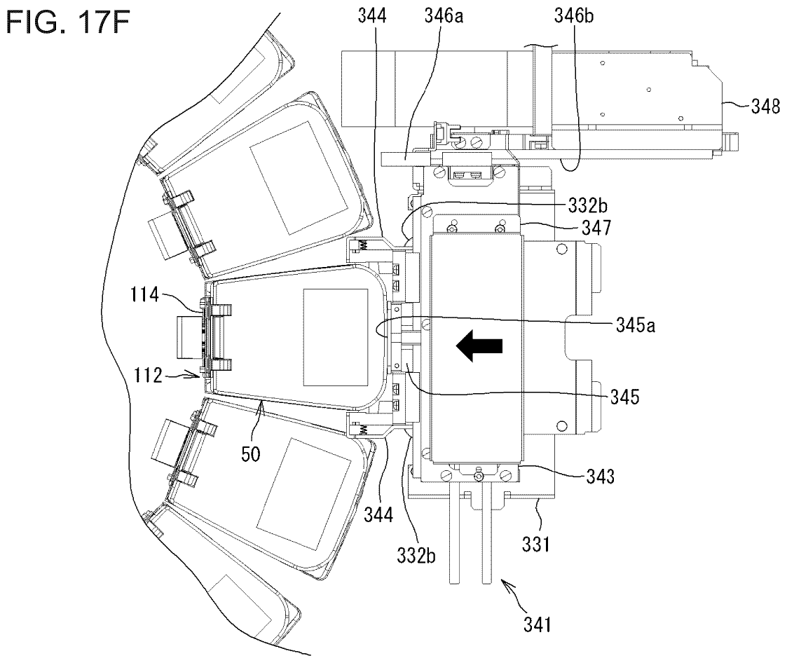

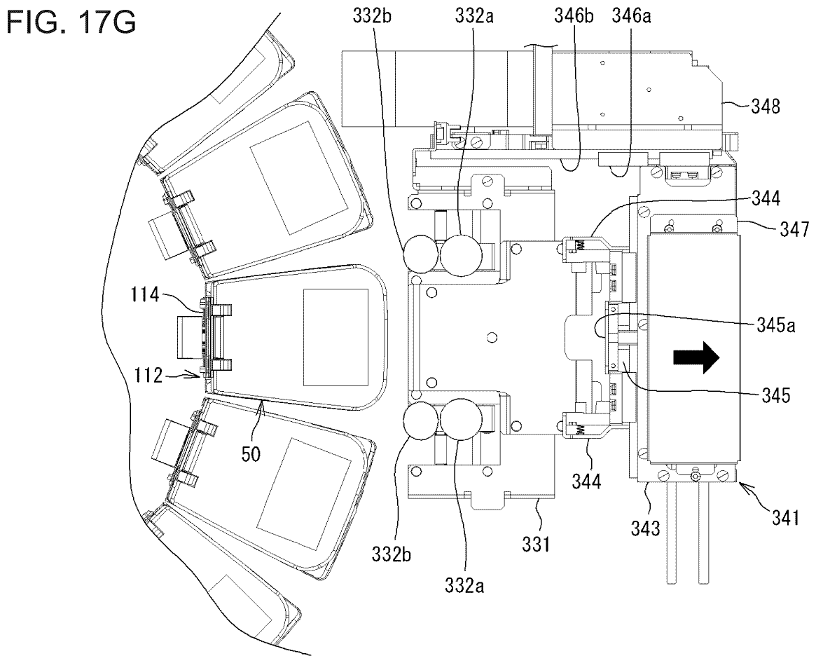

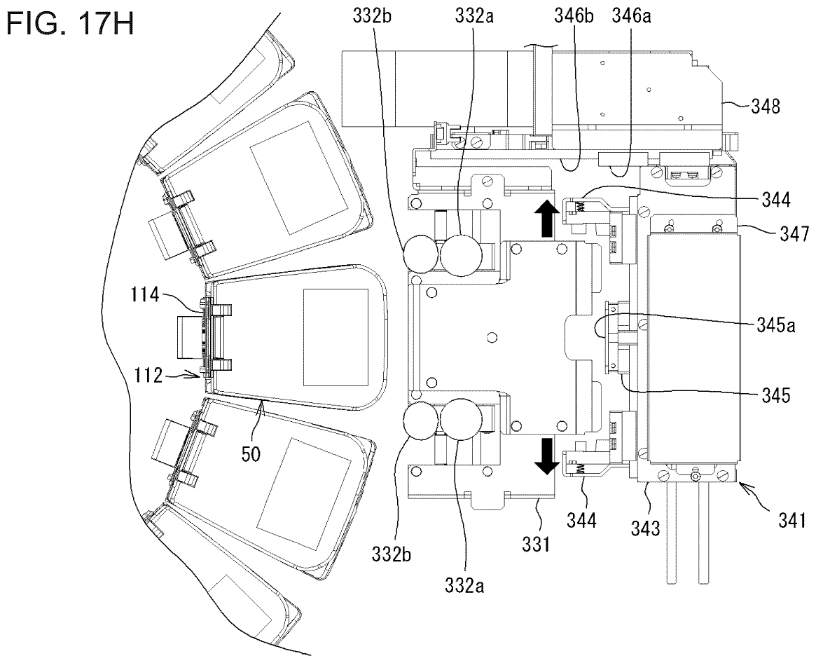

FIG. 17A to FIG. 17H are explanatory views for illustrating the second carry-in operation.

As illustrated in FIG. 17A, the second conveyor 340 moves the pushing mechanism 341 upward and downward to a height of the stand 331 on which the cassette 50 to be conveyed into the storage cylinder 110 has been placed. The pushing mechanism 341 is positioned at a specified distance behind the stand 331 on which the cassette 50 has been placed. In the example of FIG. 17A, however, a part of the catcher 344 is positioned on the front side of the rear end of the stand 331. At this time, in the pushing mechanism 341, the pair of claw portions of the catcher 344 are in a state of being separate from each other by the largest distance. Thus, when the pushing mechanism 341 is moved in the up-and-down direction, the catcher 344 does not interfere with the stand 331. This state of the pushing mechanism 341 is referred to as “second reference state”.

As illustrated in FIG. 17B, the pushing member 347 is moved forward by a predetermined thirteenth distance. In this manner, the pushing member 347 is brought closer to the cassette 50, which is a cassette to be conveyed, and the claw portions of the catcher 344 are positioned on the sides of the recessed portions 53 of the cassette 50. The contact surface 345a is separate from the rear surface of the cassette 50 by a slight distance.

As illustrated in FIG. 17C, the pair of claw portions of the catcher 344 are moved closer to each other, and the catcher 344 holds the cassette 50. The claw portions are brought into contact with the recessed portions 53 of the cassette 50. The buttons 54 of the cassette 50 are pushed by the claw portions. Thus, the pair of engaging portions 55 of the cassette 50 are separated away from each other (not shown).

As illustrated in FIG. 17D, the pushing member 347 is moved forward by a fourteenth distance under a state in which the catcher 344 is holding the cassette 50. As a result, the cassette 50 is slid forward on the stand 331, and thus the front portion of the cassette 50, that is, the cassette 50 except for its rear end portion is located on the cassette accommodating portion 111.

As illustrated in FIG. 17E, the pair of claw portions of the catcher 344 are separated away from each other. As a result, the holding of the cassette 50 by the catcher 344 is cancelled. At this time, however, the claw portions of the catcher 344 are not moved into a state in which the claw portions are separated from each other by the largest distance. That is, the claw portions are stopped while being moved within the movable range. Further, the pushing member 347 is moved forward by a fifteenth distance. As a result, the cassette 50 is pushed by the contact surface 345a to be slid further forward on the cassette accommodating portion 111.

Now, operations of the first rollers 332a and the second rollers 332b are described. In the above-mentioned operation of FIG. 17D to FIG. 17E, the first rollers 332a and the second rollers 332b are pushed and moved by the side surfaces of the cassette 50.

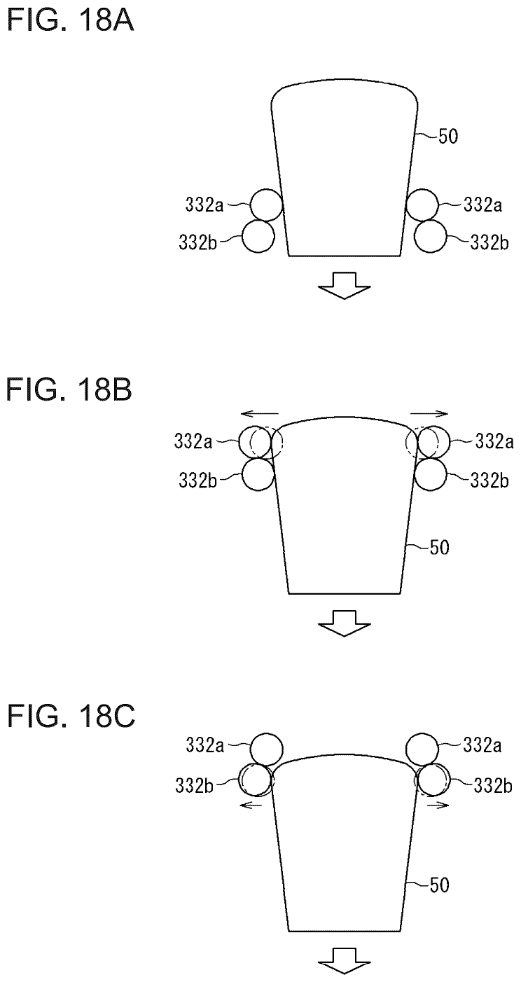

FIG. 18A to FIG. 18C are explanatory views for illustrating the operations of the first rollers 332a and the second rollers 332b.

As illustrated in FIG. 18A, first, the pair of first rollers 332a are brought into contact with the side surfaces of the cassette 50. At this time, the second rollers 332b are not in contact with the cassette 50.

As illustrated in FIG. 18B, when the cassette 50 is moved forward, the pair of first rollers 332a are pushed by the side surfaces of the cassette 50, and thus are separated away from each other. The pair of second rollers 332b are brought into contact with the side surfaces of the cassette 50.

As illustrated in FIG. 18C, when the cassette 50 is moved further forward, the cassette 50 is positioned in front of the first rollers 332a. The first rollers 332a are no longer in contact with the cassette 50, and are brought closer to each other by urging forces of the springs. The pair of second rollers 332b are pushed by the side surfaces of the cassette 50, and thus are separated away from each other.

When the cassette 50 is moved further forward, the cassette 50 is positioned in front of the second rollers 332b. The second rollers 332b are no longer in contact with the cassette 50, and are brought closer to each other by urging forces of the springs.

As illustrated in FIG. 17F, the pushing member 347 is moved forward by a sixteenth distance. As a result, the cassette 50 is pushed by the contact surface 345a to thereby complete the accommodation of the cassette 50 in the cassette accommodating portion 111. The lock portions 115 and the engaging portions 55 are brought into engagement with each other to lock the holding of the cassette 50 in the cassette accommodating portion 111.

As illustrated in FIG. 17G, the pushing member 347 is moved rearward by a seventeenth distance. As a result, the pushing member 347 is returned to an initial position, which is located at a specified distance behind the stand 331.

As illustrated in FIG. 17H, the pair of claw portions of the catcher 344 are separated away from each other to be brought into a state of being separate from each other by the largest distance, and the pushing mechanism 341 is returned to the second reference state. Through the operation described above, the second carry-in operation is completed.

Next, an operation in which the pushing mechanism 341 conveys the cassette 50 from the cassette accommodating portion 111 of the storage cylinder 110 to the cassette rack 330 (the stand 331) (hereinafter also referred to as “second carry-out operation”) is described.

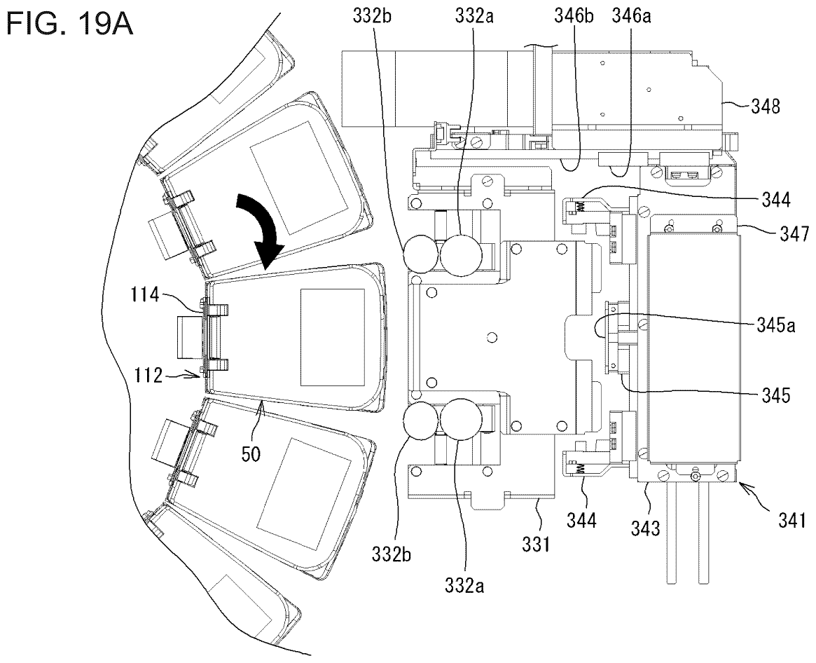

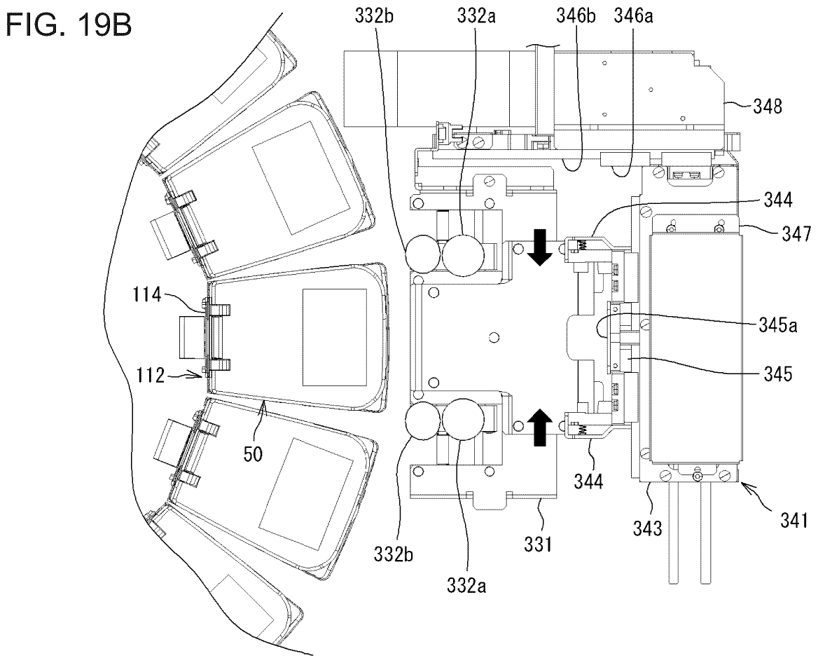

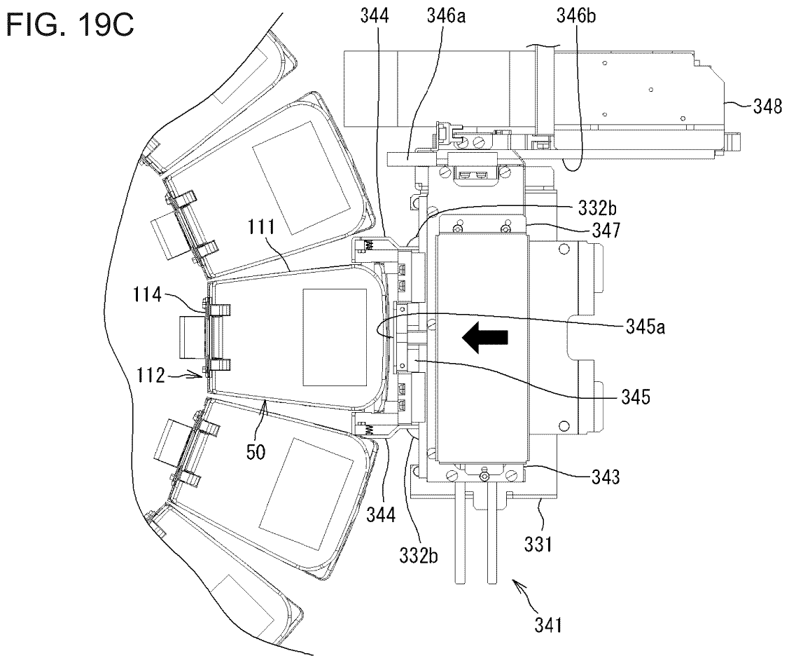

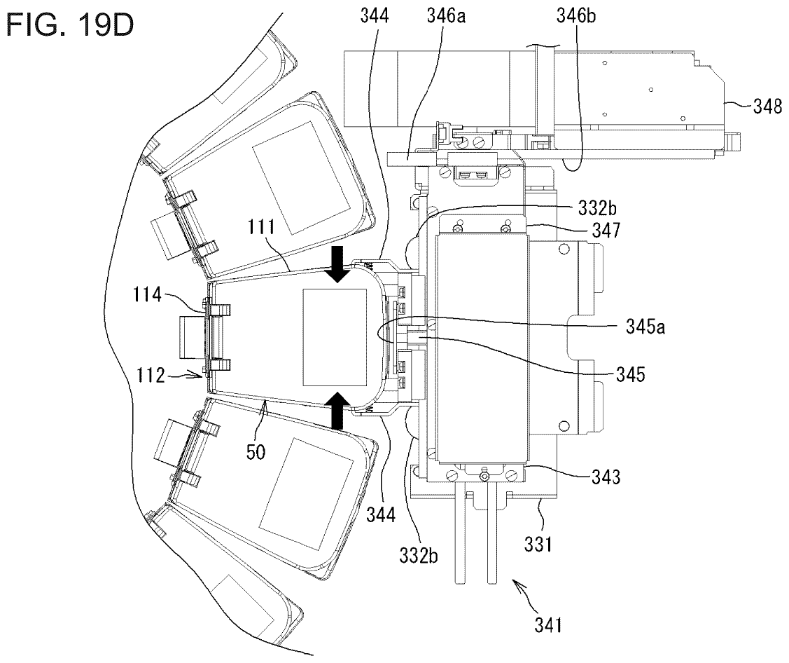

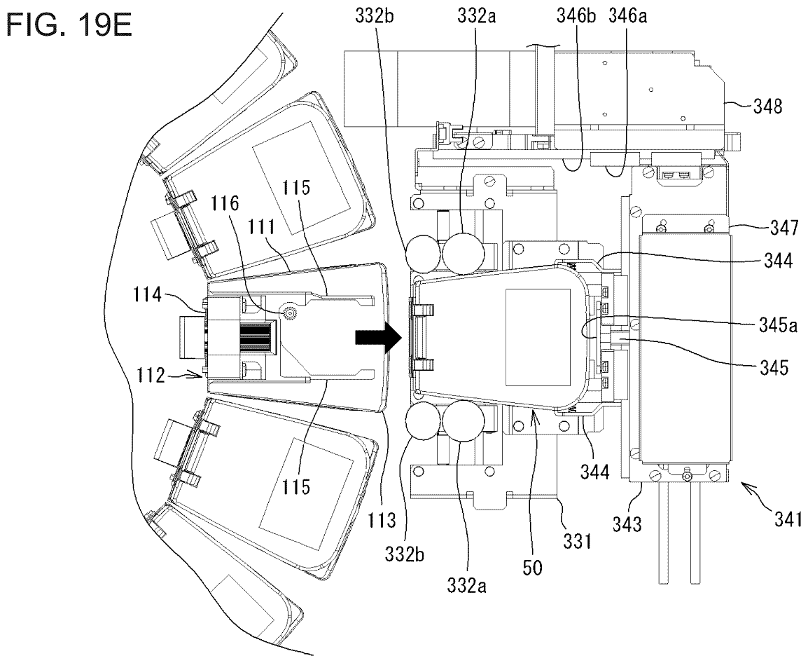

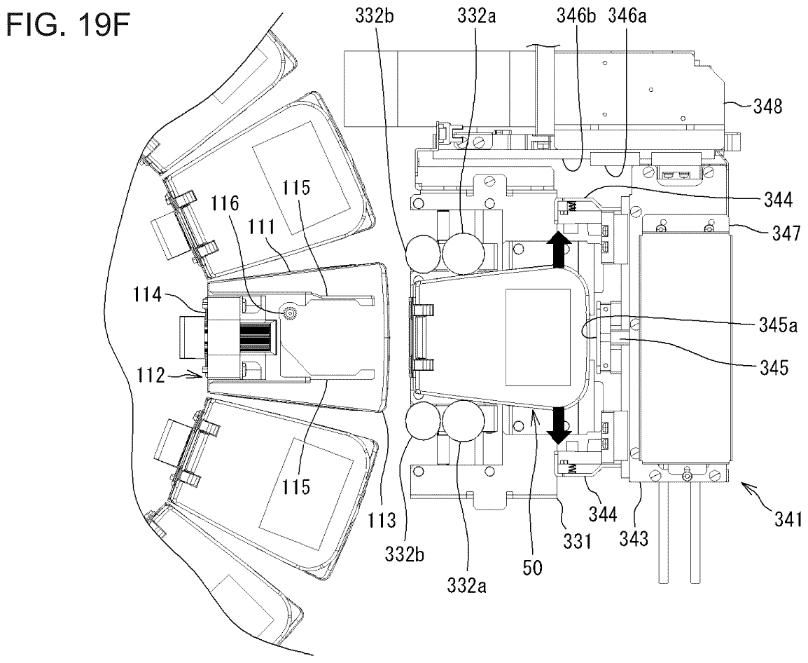

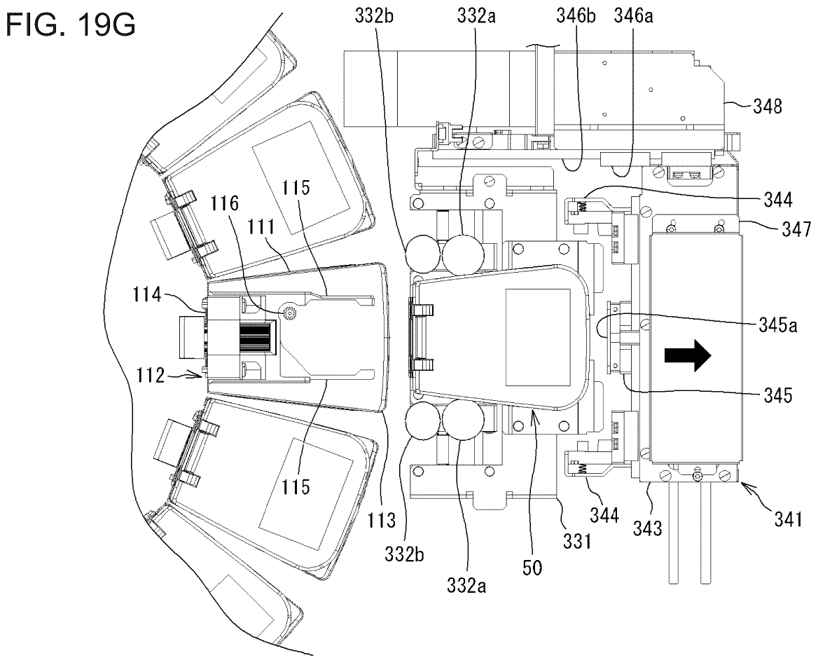

FIG. 19A to FIG. 19G are explanatory views for illustrating the second carry-out operation.

As illustrated in FIG. 19A, the storage cylinder 110 is rotated to position the cassette 50, which is a cassette to be conveyed, at the loading position 112. The second conveyor 340 moves the pushing mechanism 341 upward and downward to the height of the stand 331 of the storage cylinder 110, from which the cassette 50 is to be conveyed. At this time, the pushing mechanism 341 is in the second reference state.

As illustrated in FIG. 19B, the pair of claw portions of the catcher 344 are moved closer to each other by a predetermined amount. At this time, the pair of claw portions are away from each other by a distance larger than a distance between the claw portions at the time when the claw portions are gripping the cassette 50.

As illustrated in FIG. 19C, the pushing member 347 is moved forward by an eighteenth distance. In this manner, the pushing member 347 is brought closer to the cassette 50, which is a cassette to be conveyed, and the claw portions of the catcher 344 are positioned on the sides of the recessed portions 53 of the cassette 50. The contact surface 345a is separate from the rear surface of the cassette 50 by a slight distance.

As illustrated in FIG. 19D, the pair of claw portions of the catcher 344 are moved closer to each other, and the catcher 344 holds the cassette 50. The claw portions are brought into contact with the recessed portions 53 of the cassette 50. The buttons 54 of the cassette 50 are pushed by the claw portions. Thus, the pair of engaging portions 55 of the cassette 50 are separated away from each other, and thus the lock by the lock portions 115 is released (not shown).

As illustrated in FIG. 19E, the pushing member 347 is moved rearward by a nineteenth distance under a state in which the catcher 344 is holding the cassette 50. As a result, the cassette 50 is slid on the cassette accommodating portion 111 and the stand 331 rearward, and thus is placed on the stand 331. Through this operation, the first rollers 332a are separated from each other and then moved closer to each other and the second rollers 332b are separated from each other and then moved closer to each other, along the side surfaces of the cassette 50 in a procedure in an order reverse to the order of the above-mentioned operation.

As illustrated in FIG. 19F, the pair of claw portions of the catcher 344 are separated away from each other. As a result, the holding of the cassette 50 by the catcher 344 is cancelled. At this time, the claw portions of the catcher 344 are moved into a state in which the claw portions are separated from each other by the largest distance.

As illustrated in FIG. 19G, the pushing member is moved rearward by the twentieth distance. As a result, the pushing mechanism 341 is returned to the second reference state. Through the operation described above, the second carry-out operation is completed.

### 6. Conveyance Device

With reference to FIG. 1 and FIG. 2, the conveyance device 600 is described. The conveyance device 600 includes the conveyance head 610, the vertically-moving unit 620, and the horizontal drive unit 630. The conveyance head 610 can hold the cassette 60 with a holding mechanism. The vertically-moving unit 620 includes a rail 621 extending in the up-and-down direction and a motor, and moves the conveyance head 610 in the up-and-down direction along the rail 621. The horizontal drive unit 630 includes a rail 631 extending in the right-and-left direction and a motor, and moves the conveyance head 610 and the vertically-moving unit 620 in the right-and-left direction along the rail 631. That is, the conveyance head 610 can be moved in the up-and-down direction and the right-and-left direction on a front side of the plurality of packaging devices 100.

The conveyance device 600 moves the conveyance head 610 in the up-and-down direction, the right-and-left direction, or both of the directions to thereby position the conveyance head 610 at a position at which the conveyance head 610 is opposed to the second cassette transfer position 420. The conveyance head 610 holds the cassette 60 positioned at the second cassette transfer position 420, and pulls the cassette 60 forward (in a direction closer to the front surface 11a) from the second cassette transfer position 420. In this manner, the conveyance device 600 can receive the cassette 60 from the cassette distribution device 400.

The conveyance device 600 moves the conveyance head 610, which is holding the cassette 60, in a rightward direction, and moves the conveyance head 610 in the up-and-down direction as required. As illustrated in FIG. 2, the conveyance device 600 positions the conveyance head 610 at a position in front of a vacant one of the cassette accommodating portions 121 of one cassette storage unit 120 or one of the cassette accommodating portions 121 of the packaging device 100 for which single-dose packaging is to be performed based on a prescription. The conveyance head 610 moves the cassette 60, which is being held thereby, rearward. As a result, the cassette 60 is accommodated in the cassette accommodating portion 121. The conveyance head 610 releases the cassette 60 to thereby complete the transfer of the cassette 60 to the cassette storage unit 120.

When the cassette 60 stored in the cassette storage unit 120 is to be picked up from the drug packaging system 10, the conveyance device 600 moves the conveyance head 610 to a position at which the conveyance head 610 is opposed to the cassette accommodating portion 121 in which the cassette 60 to be picked up is accommodated. The conveyance head 610 holds the cassette 60 accommodated in the cassette accommodating portion 121, and pulls the cassette 60 forward from the cassette accommodating portion 121.

The conveyance device 600 moves the conveyance head 610, which is holding the cassette 60, in a leftward direction, and moves the conveyance head 610 in the up-and-down direction as required. The conveyance device 600 positions the conveyance head 610 at a position at which the conveyance head 610 is opposed to the second cassette transfer position 420. The conveyance head 610 moves the cassette 60, which is being held thereby, rearward. As a result, the cassette 60 is positioned at the second cassette transfer position 420. The conveyance head 610 releases the cassette 60 to thereby complete the transfer of the cassette 60 to the second cassette transfer position 420.

The cassette distribution device 400 transfers the cassette 60 placed at the second cassette transfer position 420 to the second transfer opening 530. The operator can pick up the cassette 60 from the second transfer opening 530.

### 7. Conveyance Paths for Cassettes

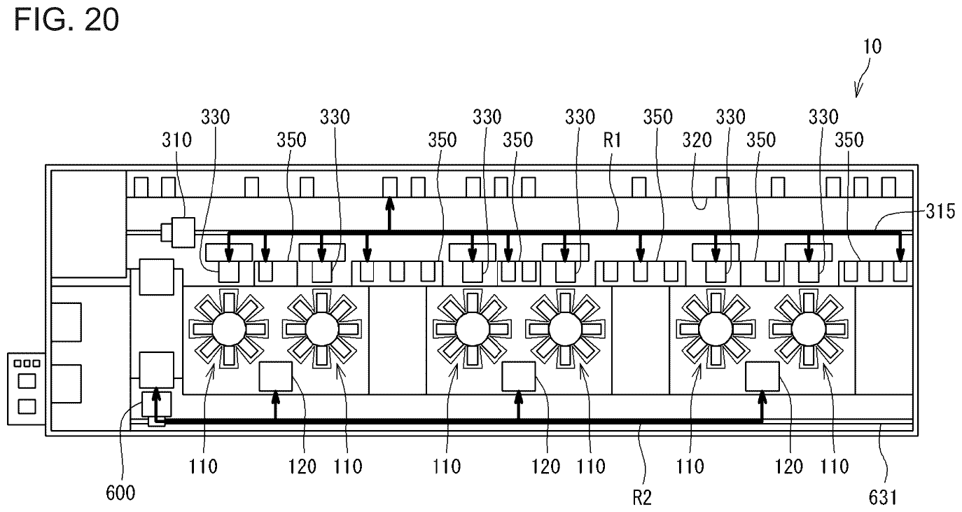

FIG. 20 is an explanatory plan view for illustrating conveyance paths for cassettes 50 and 60.

The first conveyor 310 conveys the cassette 50 between the storage shelf 320, 350 and the cassette rack 330 through a first conveyance path R1. The first conveyance path R1 is a path along at least the rail 315.

The conveyance device 600 conveys the cassette 60 through a second conveyance path R2. The second conveyance path R2 is a path along at least the rail 631.

The first conveyance path R1 is positioned at the rear of the plurality of storage cylinders 110. The second conveyance path R2 is positioned in front of the plurality of storage cylinders 110. That is, the plurality of storage cylinders 110 are positioned between the first conveyance path R1 and the second conveyance path R2.

The cassette rack 330 is in proximity to a portion (first portion) of a corresponding one of the storage cylinders 110, which is close to the first conveyance path R1. Specifically, the cassette rack 330 is closer to the first conveyance path R1 than the corresponding storage cylinder 110. The first portion is a rear portion of the storage cylinder 110, and is, for example, the cassette accommodating portion 111 located at the loading position 112.

The cassette storage unit 120 is in proximity to a portion (second portion) of each of the storage cylinders 110 on both sides of the above-mentioned cassette storage unit 120, which are close to the second conveyance path R2. Specifically, the cassette storage unit 120 is closer to the second conveyance path R2 than the storage cylinders 110 on both sides of the cassette storage unit 120. The second portion is a front portion of the storage cylinder 110.

The drug packaging system 10 can be efficiently configured in a compact fashion by arranging the first conveyance path R1, the second conveyance path R2, the storage cylinders 110, the cassette racks 330, and the cassette storage unit 120 as described above. Further, the cassettes 50 and 60 can be conveyed through short paths by arranging the first conveyance path R1 and the second conveyance path R2 so that the packaging devices 100 are located therebetween.

A more specific conveyance path for the cassettes 50 through the first conveyance path R1 is described.

(1) Conveyance Path for the Cassette 50 from the Storage Shelf 320 to the Storage Cylinder 110

The first conveyor 310 and the second conveyors 340 can convey the cassette 50 from the storage shelf 320 to the storage cylinder 110. The first conveyor 310 holds the cassette 50 accommodated in one of the accommodating portions 322 of the storage shelf 320, with the use of the conveyance head 311, and pulls out the cassette 50 from the accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 at the rear of the cassette rack 330 corresponding to a target one of the storage cylinders 110, and horizontally rotates the conveyance head 311 by another 90° so that the conveyance head 311 is opposed to the cassette rack 330. The conveyance head 311 conveys the cassette 50 to the stand 331 corresponding to the cassette accommodating portion 111 of the storage cylinder 110, which is a destination of conveyance of the cassette 50.

The storage cylinder 110 is rotated in the circumferential direction to position the cassette accommodating portion 111, which is a destination of conveyance of the cassette 50, at the loading position 112. The second conveyor 340 moves the pushing mechanism 341 upward and downward to position the pushing mechanism 341 at a height corresponding to the stand 331 on which the cassette 50 is stored. The pushing member 347 moves the cassette 50 stored on the stand 331, forward to thereby convey the cassette 50 to the cassette accommodating portion 111 located at the loading position 112.

(2) Conveyance Path for the Cassette 50 from the Storage Cylinder 110 to the Storage Shelf 320

The first conveyor 310 and the second conveyors 340 can convey the cassette 50 from the storage cylinder 110 to the storage shelf 320. The storage cylinder 110 is rotated in the circumferential direction to position the cassette accommodating portion 111, which is accommodating the cassette 50 to be conveyed, at the loading position 112.

The second conveyor 340 moves the pushing mechanism 341 upward and downward to position the pushing mechanism 341 at a height corresponding to the cassette accommodating portion 111 that is storing the cassette 50. The pushing member 347 moves the cassette 50 stored in the cassette accommodating portion 111 located at the loading position 112, rearward to thereby convey the cassette 50 to the stand 331.

The first conveyor 310 moves the conveyance head 311 to the rear side of the stand 331 on which the cassette 50 to be conveyed has been stored. The conveyance head 311 holds the cassette 50 stored on the stand 331, and pulls out the cassette 50 from the stand 331. Further, the first conveyor 310 horizontally rotates the conveyance head 311 by 90°, and moves the conveyance head 311 in the up-and-down direction and the right-and-left direction. The first conveyor 310 positions the conveyance head 311 in front of one of the accommodating portions 322 of the storage shelf 320, in which the cassette 50 has not been stored, and horizontally rotates the conveyance head 311 by another 90° so that the conveyance head 311 is opposed to the accommodating portion 322. The conveyance head 311 conveys the cassette 50 to the accommodating portion 322 to which the conveyance head 311 is opposed.

(3) Conveyance Path for the Cassette 50 from the Storage Shelf 320 to the Storage Cylinder 110

The first conveyor 310 and the second conveyors 340 can convey the cassette 50 from the storage shelf 350 to the storage cylinder 110. The first conveyor 310 holds the cassette 50 accommodated in one of the accommodating portions 322 of the storage shelf 350 with the use of the conveyance head 311, and pulls out the cassette 50 from the accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 at the rear of the cassette rack 330 corresponding to a target one of the storage cylinders 110, and horizontally rotates the conveyance head 311 by another 90° so that the conveyance head 311 is opposed to the cassette rack 330. The conveyance head 311 conveys the cassette 50 to the stand 331 corresponding to the cassette accommodating portion 111 of the storage cylinder 110, which is a destination of conveyance of the cassette 50.

The storage cylinder 110 is rotated in the circumferential direction to position the cassette accommodating portion 111, which is a destination of conveyance of the cassette 50, at the loading position 112. The second conveyor 340 moves the pushing mechanism 341 upward and downward to position the pushing mechanism 341 at a height corresponding to the stand 331 on which the cassette 50 has been stored. The pushing member 347 moves the cassette 50 stored on the stand 331 forward to thereby convey the cassette 50 to the cassette accommodating portion 111 located at the loading position 112.

(4) Conveyance Path for the Cassette 50 from the Storage Cylinder 110 to the Storage Shelf 350

The first conveyor 310 and the second conveyors 340 can convey the cassette 50 from the storage cylinder 110 to the storage shelf 350. The storage cylinder 110 is rotated in the circumferential direction to position the cassette accommodating portion 111, which is accommodating the cassette 50 to be conveyed, at the loading position 112.

The second conveyor 340 moves the pushing mechanism 341 upward and downward to position the pushing mechanism 341 at a height corresponding to the cassette accommodating portion 111 that is storing the cassette 50. The pushing member 347 moves the cassette 50 stored in the cassette accommodating portion 111 located at the loading position 112, rearward to thereby convey the cassette 50 to the stand 331.

The first conveyor 310 moves the conveyance head 311 to the rear side of the stand 331 on which the cassette 50 to be conveyed has been stored. The conveyance head 311 holds the cassette 50 stored on the stand 331, and pulls out the cassette 50 from the stand 331. Further, the first conveyor 310 horizontally rotates the conveyance head 311 by 90°, and moves the conveyance head 311 in the up-and-down direction and the right-and-left direction. The first conveyor 310 positions the conveyance head 311 in front of one of the accommodating portions 322 of the storage shelf 350, in which the cassette 50 has not been stored, and horizontally rotates the conveyance head 311 by another 90° so that the conveyance head 311 is opposed to the accommodating portion 322. The conveyance head 311 conveys the cassette 50 to the accommodating portion 322 to which the conveyance head 311 is opposed.

### (5) Conveyance Path for the Cassette 50 Between Different Storage Cylinders 110

The first conveyor 310 and the second conveyors 340 can convey the cassette 50 from one storage cylinder 110 (hereinafter also referred to as “first storage cylinder 110”) to another storage cylinder (hereinafter also referred to as “second storage cylinder 110”). The first storage cylinder 110 is rotated in the circumferential direction to thereby position the cassette accommodating portion 111, in which the cassette 50 to be conveyed is being accommodated, at the loading position 112.

The second conveyor 340 corresponding to the first storage cylinder 110 moves the pushing mechanism 341 upward and downward to position the pushing mechanism 341 at a height corresponding to the cassette accommodating portion 111 that is storing the cassette 50. The pushing member 347 moves the cassette 50 stored in the cassette accommodating portion 111 located at the loading position 112, rearward to thereby convey the cassette 50 to the stand 331.

The first conveyor 310 moves the conveyance head 311 to the rear side of the stand 331 on which the cassette 50 to be conveyed has been stored. The conveyance head 311 holds the cassette 50 stored on the stand 331, and pulls out the cassette 50 from the stand 331. Further, the first conveyor 310 horizontally rotates the conveyance head 311 by 90°, and moves the conveyance head 311 in the up-and-down direction and the right-and-left direction. The first conveyor 310 positions the conveyance head 311 at the rear of the cassette rack 330 corresponding to the second storage cylinder 110, and horizontally rotates the conveyance head 311 by another 90° so that the conveyance head 311 is opposed to the cassette rack 330. The conveyance head 311 conveys the cassette 50 to the stand 331 corresponding to the cassette accommodating portion 111 of the second storage cylinder 110, which is a destination of conveyance of the cassette 50.

The second storage cylinder 110 is rotated in the circumferential direction to position the cassette accommodating portion 111, which is a destination of conveyance of the cassette 50, at the loading position 112. The second conveyor 340 moves the pushing mechanism 341 upward and downward to position the pushing mechanism 341 at a height corresponding to the stand 331 on which the cassette 50 has been stored. The pushing member 347 moves the cassette 50 stored on the stand 331 forward to thereby convey the cassette 50 to the cassette accommodating portion 111 located at the loading position 112.

### (6) Conveyance Path for the Cassette 50 Between Different Cassette Accommodating Portions 111 of One Storage Cylinder 110

The first conveyor 310 and the second conveyors 340 can convey the cassette 50 from one cassette accommodating portion 111 (hereinafter also referred to as “first cassette accommodating portion 111”) of one storage cylinder 110 to another cassette accommodating portion 111 (hereinafter also referred to as “second cassette accommodating portion 111”) of the same storage cylinder 110.

A target storage cylinder 110 is rotated in the circumferential direction to position the first cassette accommodating portion 111, which is accommodating the cassette 50 to be conveyed, at the loading position 112.

The second conveyor 340 moves the pushing mechanism 341 upward and downward to position the pushing mechanism 341 at a height corresponding to the first cassette accommodating portion 111. The pushing member 347 moves the cassette 50 stored in the cassette accommodating portion 111 located at the loading position 112, rearward to thereby convey the cassette 50 to the stand 331.

The first conveyor 310 moves the conveyance head 311 to the rear side of the stand 331 on which the cassette 50 to be conveyed has been stored. The conveyance head 311 holds the cassette 50 stored on the stand 331, and pulls out the cassette 50 from the stand 331. Further, the first conveyor 310 moves the conveyance head 311 upward and downward to thereby position the conveyance head 311 at the rear of the stand 331 corresponding to the second cassette accommodating portion 111. The conveyance head 311 conveys the cassette 50 to the stand 331 to which the conveyance head 311 is opposed.

The storage cylinder 110 is rotated in the circumferential direction to position the second cassette accommodating portion 111 at the loading position 112. The second conveyor 340 moves the pushing mechanism 341 upward and downward to position the pushing mechanism 341 at a height corresponding to the stand 331 on which the cassette 50 has been stored. The pushing member 347 moves the cassette 50 stored on the stand 331 forward to thereby convey the cassette 50 to the second cassette accommodating portion 111.

(7) Conveyance Path for the Cassette 50 from the Storage Shelf 320 to the Storage Shelf 350

The first conveyor 310 can convey the cassette 50 from the storage shelf 320 to the storage shelf 350. The first conveyor 310 holds the cassette 50 accommodated in one of the accommodating portions 322 of the storage shelf 320 with the use of the conveyance head 311, and pulls out the cassette 50 from the accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 in front of one of the accommodating portions 322 of the storage shelf 350, in which the cassette 50 has not been stored, and horizontally rotates the conveyance head 311 by another 90° so that the conveyance head 311 is opposed to the accommodating portion 322. The conveyance head 311 conveys the cassette 50 to the accommodating portion 322 to which the conveyance head 311 is opposed.

(8) Conveyance Path for the Cassette 50 from the Storage Shelf 350 to the Storage Shelf 320

The first conveyor 310 and the second conveyors 340 can convey the cassette 50 from the storage shelf 350 to the storage shelf 320. The first conveyor 310 holds the cassette 50 accommodated in one of the accommodating portions 322 of the storage shelf 350 with the use of the conveyance head 311, and pulls out the cassette 50 from the accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 in front of one of the accommodating portions 322 of the storage shelf 320, in which the cassette 50 has not been stored, and horizontally rotates the conveyance head 311 by another 90° so that the conveyance head 311 is opposed to the accommodating portion 322. The conveyance head 311 conveys the cassette 50 to the accommodating portion 322 to which the conveyance head 311 is opposed.

### (9) Conveyance Path for the Cassette 50 Between Different Accommodating Portions 322 of the Storage Shelf 320

The first conveyor 310 can convey the cassette 50 from one accommodating portion 322 (hereinafter also referred to as “first accommodating portion 322”) to another accommodating portion 322 (hereinafter also referred to as “second accommodating portion 322”) of the storage shelf 320. The first conveyor 310 holds the cassette 50 accommodated in the first accommodating portion 322 of the storage shelf 320 with the use of the conveyance head 311, and pulls out the cassette 50 from the first accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 in front of the second accommodating portion 322 of the storage shelf 320, and horizontally rotates the conveyance head 311 by 90° so that the conveyance head 311 is opposed to the second accommodating portion 322. The conveyance head 311 conveys the cassette 50 to the second accommodating portion 322.

### (10) Conveyance Path for the Cassette 50 Between Different Accommodating Portions 322 of the Storage Shelf 350

The first conveyor 310 can convey the cassette 50 from one accommodating portion 322 (hereinafter also referred to as “third accommodating portion 322”) to another accommodating portion 322 (hereinafter also referred to as “fourth accommodating portion 322”) of the storage shelf 350. The first conveyor 310 holds the cassette 50 accommodated in the third accommodating portion 322 of the storage shelf 350 with the use of the conveyance head 311, and pulls out the cassette 50 from the third accommodating portion 322. Further, the first conveyor 310 horizontally rotates the conveyance head 311 by 90°, and moves the conveyance head 311 in the up-and-down direction and the right-and-left direction. The first conveyor 310 positions the conveyance head 311 in front of the fourth accommodating portion 322 of the storage shelf 350, and horizontally rotates the conveyance head 311 by 90° so that the conveyance head 311 is opposed to the fourth accommodating portion 322. The conveyance head 311 conveys the cassette 50 to the fourth accommodating portion 322.

The drug packaging system 10 includes conveyance paths for the cassettes 50 other than the first conveyance path R1 and the second conveyance path R2. One conveyance path is a conveyance path between the first transfer opening 520 of the operation device 500 and the storage shelf 320. That is, the cassette distribution device 400 conveys the cassette 50 placed in the first transfer opening 520 to the first cassette transfer position 410, and then the first conveyor 310 conveys the cassette 50 placed at the first cassette transfer position 410 to the accommodating portion 322 of the storage shelf 320. Further, the first conveyor 310 conveys the cassette 50 accommodated in the accommodating portion 322 of the storage shelf 320 to the first cassette transfer position 410, and then the cassette distribution device 400 conveys the cassette 50 placed at the first cassette transfer position 410 to the first transfer opening 520.

Another conveyance path is a conveyance path between the storage shelf 320 and the storage cylinder 110. That is, the first conveyor 310 conveys the cassette 50 accommodated in the accommodating portion 322 of the storage shelf 320 to the cassette rack 330, and then the second conveyor 340 conveys the cassette 50 accommodated in the cassette rack 330 to the cassette accommodating portion 111 of the storage cylinder 110, which is located at the loading position 112. Further, the second conveyor 340 conveys the cassette 50 accommodated in the cassette accommodating portion 111 of the storage cylinder 110, which is located at the loading position 112, to the cassette rack 330, and then the first conveyor 310 conveys the cassette 50 accommodated in the cassette rack 330 to the accommodating portion 322 of the storage shelf 320.

Still another conveyance path is a conveyance path for conveying the cassette 50 between the first transfer opening 520 of the operation device 500 and the storage cylinder 110 without passage through the storage shelf 320. That is, the cassette distribution device 400 conveys the cassette 50 placed in the first transfer opening 520 to the first cassette transfer position 410. Then, the first conveyor 310 conveys the cassette 50 placed at the first cassette transfer position 410 to the cassette rack 330, and the second conveyor 340 conveys the cassette 50 accommodated in the cassette rack 330 to the cassette accommodating portion 111 of the storage cylinder 110, which is located at the loading position 112. Further, the second conveyor 340 conveys the cassette 50 accommodated in the cassette accommodating portion 111 of the storage cylinder 110, which is located at the loading position 112, to the cassette rack 330. The first conveyor 310 conveys the cassette 50 accommodated in the cassette rack 330 to the first cassette transfer position 410, and then the cassette distribution device 400 conveys the cassette 50 placed at the first cassette transfer position 410 to the first transfer opening 520.

The above-mentioned drug packaging operation performed by the packaging unit 150 can be performed in parallel to a replacement operation for the cassette 50, 60. That is, while the packaging unit 150 is packaging drugs in the packaging bodies 71, the second conveyor 340 can convey the cassette 50, which is no longer required, from the cassette accommodating portion 111 of the storage cylinder 110 to the cassette rack 330, and the first conveyor 310 can convey the cassette 50 from the cassette rack 330 to the accommodating portion 322 of the storage shelf 320 or the first cassette transfer position 410 for the cassette distribution device 400. Further, while the packaging unit 150 is packaging drugs in the packaging bodies 71, the first conveyor 310 can also convey the cassette 50 from the accommodating portion 322 of the storage shelf 320 to the first cassette transfer position 410 for the cassette distribution device 400. While the packaging unit 150 is packaging drugs in the packaging bodies 71, the cassette distribution device 400 can convey the cassette 50 placed at the first cassette transfer position 410 to the first transfer opening 520.

Further, while the packaging unit 150 is packaging drugs in the packaging bodies 71, the cassette distribution device 400 can convey the cassette 50, which is newly placed in the first transfer opening 520, to the first cassette transfer position 410. While the packaging unit 150 is packaging drugs in the packaging bodies 71, the first conveyor 310 can convey the cassette 50 from the first cassette transfer position 410 to the accommodating portion 322 of the storage shelf 320 or the cassette rack 330, and can also convey the cassette 50 from the accommodating portion 322 of the storage shelf 320 to the cassette rack 330. While the packaging unit 150 is packaging drugs in the packaging bodies 71, the second conveyor 340 can convey the cassette 50 from the cassette rack 330 to the cassette accommodating portion 111 of the storage cylinder 110.

While the packaging unit 150 is packaging drugs in the packaging bodies 71, the conveyance device 600 can convey the cassette 60, which is no longer required, from the cassette accommodating portion 121 of the cassette storage unit 120 to the second cassette transfer position 420, and then the cassette distribution device 400 can convey the cassette 60 placed at the second cassette transfer position 420 to the second transfer opening 530. Further, while the packaging unit 150 is packaging drugs in the packaging bodies 71, the cassette distribution device 400 can convey the cassette 60, which is newly placed in the second transfer opening 530, to the second cassette transfer position 420, and then the conveyance device 600 can convey the cassette 60 from the second cassette transfer position 420 to the cassette accommodating portion 121 of the cassette storage unit 120.

### 8. Modification Examples

The above-mentioned embodiment is one example, and the drug packaging system 10 is not limited to that described in the embodiment. For example, the first storage area has been described as the storage cylinder 110. However, the first storage area is not limited thereto. The first storage area may have, for example, a shelf shape, and is not always required to be rotatable. The configuration of the storage cylinder 110 is not limited to a configuration in which the plurality of cassette accommodating portions 111 are fixed to the columnar body in the center and the plurality of cassette accommodating portions 111 are rotated together with the columnar body. For example, the cassette accommodating portions 111 may be mounted to an annular belt conveyance unit that is movable independently of the columnar body so that the cassette accommodating portions 111 can be moved in an annular manner by driving the belt conveyance unit. Further, the arrangement of the plurality of cassette accommodating portions 111 is not limited to an annular pattern. For example, the plurality of cassette accommodating portions 111 may be arranged in an elliptical pattern so that the cassette accommodating portions 111 are moved along an ellipse, or may be arranged in a rectangular ring pattern so that the cassette accommodating portions 111 are moved along the rectangular ring. The cassette holding portion that holds the plurality of cassettes on one plane and can move the plurality of cassettes, which are being held, on the plane may be made up of the plurality of cassette accommodating portions 111 that are moved along a circular ring, may be made up of the plurality of cassette accommodating portions 111 that are moved along the ellipse, or may be made up of the plurality of cassette accommodating portions 111 that are moved along a rectangular ring. Further, the cassette holding portion may be made up of the plurality of cassette accommodating portions 111 that are moved along a straight line or a curved line.

Description has been given of the configuration in which the cassette 50 is conveyed by the first conveyor 310 between the storage shelf 320 and the cassette rack 330, and the cassette 50 is conveyed by the second conveyor 340 between the cassette rack 330 and the storage cylinder 110. However, the configuration is not limited to that described above. The cassette 50 may be conveyed by one conveyor between the storage shelf 320 and the cassette rack 330 and between the cassette rack 330 and the storage cylinder 110.

The first conveyance path R1 and the second conveyance path R2 are arranged so that the packaging devices 100 are located therebetween. However, the arrangement of the first conveyance path R1 and the second conveyance path R2 is not limited to that described above. For example, the first conveyance path R1 and the second conveyance path R2 may be arranged on the same side with respect to the packaging devices 100. That is, the first conveyor 310 and the conveyance device 600 may be arranged on the same side with respect to the packaging devices 100.

The first transfer opening 520 and the second transfer opening 530 are formed in the left side surface 11c of the drug packaging system 10. However, the position at which the first transfer opening 520 and the second transfer opening 530 are formed is not limited to that described above. For example, the first transfer opening 520 and the second transfer opening 530 may be formed in the front surface 11a of the drug packaging system 10. As another example, the first transfer opening 520 and the second transfer opening 530 may be formed in different surfaces of the drug packaging system 10, respectively. For example, the first transfer opening 520 may be formed in the front surface 11a, and the second transfer opening 530 may be formed in the left side surface 11c.

Description has been given of the configuration in which the entirety of the drug packaging system 10 is covered with the casing 11. However, the configuration of the drug packaging system 10 is not limited to that described above. The entirety of the drug packaging system 10 is not always required to be covered with one casing. In this case, for example, the packaging devices 100 and the storage shelf 320 are arranged spaced apart from each other, and the first conveyor 310 conveys the cassette 50 between the storage shelf 320 and the cassette rack 330 adjacent to the packaging device 100.

In the embodiment described above, description has been given of the configuration in which the pushing mechanism 341 of the second conveyor 340 conveys one cassette 50 to the cassette rack 330 and picks up one cassette 50 from the cassette rack 330. However, the configuration is not limited to that described above. For example, the cassette rack 330 may include a first stand 331 and a second stand 331 that are arranged side by side in the right-and-left direction, and the pushing mechanism 341 may be capable of conveying a plurality of (for example, two) cassettes 50 to the first stand 331 and the second stand 331 at the same time or in order. The pushing mechanism 341 may be capable of picking up a plurality of (for example, two) cassettes 50 from the first stand 331 and the second stand 331 at the same time or in order. Further, the conveyance head 311 of the first conveyor 310 may be capable of holding a plurality of (for example, two) cassettes 50 at the same time and conveying the plurality of cassettes, which are being held, to the first stand 331 and the second stand 331 at the same time or in order, and the conveyance head 311 may be capable of picking up a plurality of (for example, two) cassettes 50 from the first stand 331 and the second stand 331 at the same time or in order.

In the embodiment described above, description has been given of the configuration in which the cassette distribution device 400 conveys the cassettes 50 between the first transfer opening 520 and the first cassette transfer position 410 one by one. However, the conveyance of the cassettes 50 is not limited to that described above. A plurality of first transfer openings 520 may be formed and a plurality of first cassette transfer positions 410 may be set so that the cassette distribution device 400 is capable of conveying one or a plurality of cassettes 50 from one of the first transfer openings 520 to one of the first cassette transfer positions 410, and, at the same time, conveying another one or another plurality of cassettes 50 from another one of the first cassette transfer positions 410 to another one of the first transfer openings 520.

The first conveyor 310 may include a plurality of conveyance heads 311, and the conveyance heads 311 can be moved independently of each other. For example, in a case in which the cassette 50 is conveyed from the outside into the drug packaging system 10 simultaneously with the conveyance of the cassette 50 from the drug packaging system 10 to the outside, while a cassette to be conveyed to the outside is picked up by one of the conveyance heads 311 from the storage shelf 320, 350, and the conveyance head 311 holding the cassette 50 is being moved to the first cassette transfer position 410, a cassette to be conveyed into the drug packaging system 10 may be picked up by another one of the conveyance heads 311 from the first cassette transfer position 410, and the conveyance head 311 holding the cassette 50 may be moved to the storage shelf 320, 350.

### 9. Notes

### (Note 1)

A drug packaging system includes:

a first storage area including a storage cylinder having a columnar shape and being rotatable in a circumferential direction, the storage cylinder being for storing a plurality of cassettes containing drugs and for dispensing the drugs from the stored cassettes;

a second storage area, which is adjacent to the storage cylinder, and in which a plurality of cassettes are allowed to be stored;

a first conveyor, which conveys the cassette between the storage cylinder and the second storage area; and

a packaging unit, which packages the drugs dispensed from the cassette stored in the storage cylinder, in a packaging body for each dose unit.

### (Note 2)

In the drug packaging system of Note 1,

the storage cylinder includes a plurality of cassette accommodating portions, each being capable of accommodating a cassette,

the plurality of cassette accommodating portions are arranged in the circumferential direction of the storage cylinder, and

the first conveyor conveys the cassette from the storage area to one of the plurality of cassette accommodating portions.

### (Note 3)

In the drug packaging system of Note 2,

when the storage cylinder is rotated in the circumferential direction, the plurality of cassette accommodating portions are allowed to pass through a specific loading position in order, and

the first conveyor loads the cassette to the cassette accommodating portion located at the loading position, by conveying the cassette from the second storage area to the loading position.

### (Note 4)

In the drug packaging system of any one of Notes 1 to 3, the drug packaging system further includes a third storage area for storing a cassette containing drugs and dispensing the drugs from the stored cassette,

the storage cylinder includes a plurality of storage cylinders arranged in a first direction, and

the third storage area is positioned in a space defined by adjacent two of the storage cylinders.

### (Note 5)

In the drug packaging system of Note 4, the drug packaging system further includes a supply unit, which supplies the drugs dispensed from the cassette stored in the storage cylinder and the drugs dispensed from the cassette stored in the third storage area, to the packaging unit.

### (Note 6)

In the drug packaging system of Note 4 or 5,

the cassette stored in the storage cylinder is a first cassette containing the same type of drugs, and

the cassette stored in the third storage area is a second cassette containing a plurality of types of drugs.

### (Note 7)

In the drug packaging system of Note 6, the drug packaging system further includes a second conveyor, which conveys the second cassette to the second storage area through a second conveyance path different from a first conveyance path through which the first cassette is to be conveyed by the first conveyor.

### (Note 8)

In the drug packaging system of Note 7,

the storage cylinder is positioned between the first conveyance path and the second conveyance path,

the second storage area is in proximity to a first portion of the storage cylinder, the first portion being close to the first conveyance path, and

the third storage area is in proximity to a second portion of the storage cylinder, the second portion being close to the second conveyance path.

### (Note 9)

In the drug packaging system of Note 8, the drug packaging system further includes a casing that accommodates the first storage area, the second storage area, and the third storage area,

the casing includes a first surface, a second surface, and a third surface,

the first surface and the second surface are two surfaces opposite to each other,

the third surface connects the first surface and the second surface to each other,

the first conveyance path is closer to the first surface than the first storage area,

the second conveyance path is closer to the second surface than the first storage area, and

the third surface includes:
a first transfer opening for receiving the first cassette conveyed through the first conveyance path; and
a second transfer opening for receiving the second cassette conveyed through the second conveyance path.

### (Note 10)

A drug packaging system includes:

a cassette holding portion, which holds a plurality of cassettes, each containing drugs, in one plane, and is capable of moving the plurality of cassettes being held, on the plane; and

a conveyor, which is arranged at a fixed position in the same plane as the plane in which the plurality of cassettes are held by the cassette holding portion, and loads the cassette into the cassette holding portion and picks up the cassette from the cassette holding portion.

### (Note 11)

In the drug packaging system of Note 10, the cassette holding portion holds the plurality of cassettes in an annular manner on the plane, and is capable of circulating the plurality of cassettes held in the annular manner.

### (Note 12)

In the drug packaging system of Note 11, the cassette holding portion holds the plurality of cassettes in an annular manner.

### (Note 13)

In the drug packaging system of any one of Notes 10 to 12, the conveyor loads the cassette to the cassette holding portion, and picks up the cassette from the cassette holding portion by linearly moving the cassette on the plane.

### (Note 14)

In the drug packaging system of Note 13,

the cassette holding portion includes a plurality of lock portions that lock holding of each of the plurality of cassettes,

the conveyor includes an unlocking portion that cancels the lock of the holding of the cassette by the lock portions, and

the conveyor picks up the cassette from the cassette holding portion in the horizontal direction under a state in which the lock of the holding of the cassette is cancelled by the unlocking portion.

### (Note 15)

In the drug packaging system of Note 14, the conveyor causes the locking portions to lock the holding of the cassette by pushing the cassette into the cassette holding portion in the horizontal direction.

### (Note 16)

In the drug packaging system of any one of Notes 10 to 15,

the cassette holding portion is capable of dispensing the drugs from each of the plurality of cassettes being held, and

the drug packaging system further includes a packaging unit that packages the drugs dispensed from the cassette held by the cassette holding portion.

### (Note 17)

In the drug packaging system of any one of Notes 10 to 16,

the cassette holding portion includes a plurality of holding tables arranged on the plane, the holding tables being for holding the plurality of cassettes, the cassette holding portion being capable of moving the plurality of holding tables on the plane, and

the conveyor picks up the cassette from the holding table on which the cassette is being held, and loads the cassette onto the holding table on which the cassette is not being held.

### (Note 18)

In the drug packaging system of Note 17,

the conveyor picks up the cassette from the holding table located at a specific position in the cassette holding portion, and loads the cassette onto the holding table located at the specific position.

### (Note 19)

In the drug packaging system of Note 18,

the plurality of holding tables are arranged in an annular manner,

the cassette holding portion is capable of circulating the plurality of holding tables arranged in the annular manner, and

the specific position is a position on a straight line that connects a center of circulation of the plurality of cassettes in the cassette holding portion and the conveyor.

### (Note 20)

A drug packaging system includes:

a cassette holding portion, which holds a plurality of cassettes, each containing drugs, and is capable of dispensing the drugs from each of the plurality of cassettes being held;

a storage for storing the plurality of cassettes before being supplied to the cassette holding portion and the plurality of cassettes after being picked up from the cassette holding portion, and

the storage includes:
an intermediate storage adjacent to the cassette holding portion in a first direction, and the intermediate storage being for storing the cassette that is transferred to and from the cassette holding portion; and
a first storage and a second storage, which are arranged on both sides of the intermediate storage in a second direction intersecting with the first direction, the first storage and the second storage each being for storing the cassette before being supplied to the intermediate storage and the cassette after being picked up from the intermediate storage.

### (Note 21)

In the drug packaging system of Note 20,

the cassette holding portion includes:
a first plane holding portion, which holds the plurality of the cassettes on a first plane; and
a second plane holding portion, which is arranged in a vertical direction with respect to the first plane holding portion, and holds the plurality of cassettes on a second plane being parallel to the first plane,

the intermediate storage includes:
a first plane storage adjacent to the first plane holding portion in the first plane, the first plane storage being for transfer of the cassette to and from the first plane holding portion; and
a second plane storage adjacent to the second plane holding portion in the second plane, the second plane storage being for transfer of the cassette to and from the second plane holding portion.

### (Note 22)

In the drug packaging system of Note 21,

each of the first storage and the second storage includes a plurality of storage shelves arranged vertically, and

each of the plurality of d stores the plurality of cassettes arranged in the second direction.

### (Note 23)

In the drug packaging system of any one of Notes 20 to 22, the drug packaging system further includes:

a first conveyor that conveys the cassette stored in the intermediate storage to the first storage or the second storage, and conveys the cassette stored in the first storage or the second storage to the intermediate storage; and

a second conveyor that conveys one of the plurality of cassettes held by the cassette holding portion to the intermediate storage by moving the cassette in the first direction, and conveys the cassette stored in the intermediate storage to the cassette holding portion by moving the cassette in an opposite direction to the first direction.

### (Note 24)

In the drug packaging system of Note 23, the first conveyor is capable of conveying the cassette between the first storage and the second storage.

### (Note 25)

In the drug packaging system of Note 23 or 24, the first conveyor conveys the cassette in a conveyance space adjacent to the first storage, the second storage, and the intermediate storage in the first direction.

### (Note 26)

In the drug packaging system of Note 25, the storage further includes a third storage for storing the cassette including a plurality of cassettes, the third storage being arranged in the first direction across the conveyance space with respect to the first storage, the second storage, and the intermediate storage.

### (Note 27)

In the drug packaging system of Note 26, the first conveyor is capable of conveying the cassette stored in the intermediate storage to the third storage, and conveying the cassette stored in the third storage to the intermediate storage.

### (Note 28)

In the drug packaging system of Note 27, the first conveyor is capable of conveying the cassette between the first storage, the second storage, and the third storage.

### (Note 29)

In the drug packaging system of any one of Notes 23 to 28,

the cassette holding portion includes:
a first cassette holding portion, which holds the plurality of cassettes, each containing the drugs, and is capable of dispensing the drugs from each of the plurality of cassettes being held; and
a second cassette holding portion, which is adjacent to the first cassette holding portion in the second direction, holds the plurality of cassettes, each containing the drugs, and is capable of dispensing the drugs from each of the plurality of cassettes being held,

the intermediate storage includes:
a first intermediate storage adjacent to the first cassette holding portion in the first direction, the first intermediate storage being for transfer of the cassette to and from the first cassette holding portion; and
a second intermediate storage adjacent to the second cassette holding portion in the first direction, the second intermediate storage being for transfer of the cassette to and from the second cassette holding portion, and

the first storage is arranged between the first intermediate storage and the second intermediate storage in the second direction.

### (Note 30)

In the drug packaging system of Note 29, the first conveyor is capable of conveying the cassette from the first intermediate storage to the second intermediate storage, or from the second intermediate storage to the first intermediate storage.

### (Note 31)

A drug packaging system includes:

a cassette holding portion, which holds a plurality of cassettes, each containing drugs, and is capable of dispensing the drugs from each of the plurality of cassettes being held;

a cassette rack, which is adjacent to the cassette holding portion in a first direction and allows temporary placement of the cassette, which is before being supplied to the cassette holding portion, and temporary placement of the cassette, which is after being picked up from the cassette holding portion; and

a first conveyor that conveys the cassette, which is before being supplied to the cassette holding portion, to the cassette rack by sliding the cassette from a first end portion of the cassette rack in the first direction in an opposite direction to the first direction, and receives the cassette, which is after being picked up from the cassette holding portion, from the cassette rack by sliding the cassette from the first end portion of the cassette rack in the first direction.

### (Note 32)

In the drug packaging system of Note 31,

the first conveyor includes:
a contact portion to be brought into contact with the cassette, the contact portion being movable in the first direction and the opposite direction to the first direction; and
a support portion arranged below the contact portion, the support portion being movable in the first direction and the opposite direction to the first direction, and

when conveying the cassette, which is before being supplied to the cassette holding portion, to the cassette rack, the first conveyor slides the cassette from an upper surface of the support portion to an upper surface of the cassette rack by moving the support portion in the opposite direction to the first direction under a state in which a height of the support portion is matched with a height of the cassette rack, and moving the contact portion in the opposite direction to the first direction under a state in which the contact portion is in contact with the cassette.

### (Note 33)

In the drug packaging system of Note 32,

the contact portion includes a projection protruding upward, and

when conveying the cassette, which is before being supplied to the cassette holding portion, to the cassette rack, the first conveyor slides the cassette from the upper surface of the support portion to the upper surface of the cassette rack by moving the contact portion in the opposite direction to the first direction under a state in which the projection is inserted in a recessed portion formed in one end of a bottom surface of the cassette.

### (Note 34)

In the drug packaging system of Note 33,

when receiving the cassette, which is after being picked up from the cassette holding portion, from the cassette rack, the first conveyor slides the cassette from the upper surface of the cassette rack to the upper surface of the support portion, by moving the contact portion in the opposite direction to the first direction to insert the projection into the recessed portion of the cassette placed in the cassette rack, moving the support portion in the opposite direction to the first direction under a state in which the height of the support portion is matched with the height of the cassette rack, and moving the contact portion in the first direction.

### (Note 35)

In the drug packaging system of any one of Notes 32 to 34,

the cassette includes a pair of protruding portions protruding from both sides in a second direction,

the support portion includes a pair of guide portions, which extend in the first direction, each have a retaining surface facing downward, and are separate from each other in the second direction, and

when the contact portion of the first conveyor is moved in the first direction or the opposite direction to the first direction relative to the support portion, the retaining surfaces of the pair of guide portions are opposed to upper surfaces of the pair of protruding portions, respectively.

### (Note 36)

In the drug packaging system of any one of Notes 31 to 35, the drug packaging system further includes a storage for storing the cassette, which is before being supplied to the cassette holding portion, and the cassette, which is after being picked up from the cassette holding portion, and

the first conveyor conveys the cassette, which is before being supplied to the cassette holding portion and is stored in the storage, from the storage to the cassette rack, and conveys the cassette, which is after being picked up from the cassette holding portion, from the cassette rack to the storage.

### (Note 37)

In the drug packaging system of Note 36,

the storage includes a first storage and a second storage that are arranged on both sides of the cassette rack in a second direction intersecting with the first direction, and

the first conveyor is moved in the second direction and an opposite direction to the second direction through a conveyance space adjacent to the cassette rack in the first direction, to convey the cassette.

### (Note 38)

In the drug packaging system of Note 36 or 37,

the storage includes a third storage arranged apart from the cassette rack in the first direction, and

the first conveyor is moved in a second direction intersecting with the first direction through a conveyance space between the cassette rack and the storage to convey the cassette.

### (Note 39)

In the drug packaging system of any one of Notes 31 to 38, the drug packaging system further includes a second conveyor that conveys the cassette, which is before being supplied to the cassette holding portion, from the cassette rack to the cassette holding portion by sliding the cassette from a second end portion, which is in the direction opposite to the first direction, of the cassette rack in the opposite direction to the first direction, and conveys the cassette held by the cassette holding portion from the cassette holding portion to the cassette rack by sliding the cassette from the second end portion of the cassette rack in the first direction.

### (Note 40)

In the drug packaging system of Note 39,

the second conveyor includes a contact surface to be brought into contact with an end surface of the cassette in the first direction, and

when conveying the cassette, which is before being supplied to the cassette holding portion, from the cassette rack to the cassette holding portion, the second conveyor slides the cassette, from an upper surface of the cassette rack to the cassette holding portion by being moved in the opposite direction to the first direction under a state in which the contact surface is in contact with the end surface of the cassette in the first direction.

### (Note 41)

In the drug packaging system of Note 40,

the second conveyor includes a pair of claw portions that can be moved closer to each other or away from each other in the second direction, and

when conveying the cassette, which is before being supplied to the cassette holding portion, from the cassette rack to the cassette holding portion, the second conveyor places a part of a bottom surface of the cassette on an end portion of the cassette holding portion in the first direction by moving the cassette held in the cassette rack in the opposite direction to the first direction under a state in which the cassette held in the cassette rack is held between the pair of claw portions, and brings the contact surface into contact with the end surface of the cassette in the first direction by separating the claw portions from the cassette, and being further moved in the opposite direction to the first direction.

### (Note 42)

In the drug packaging system of Note 41,

when receiving the cassette held by the cassette holding portion from the cassette holding portion, the second conveyor slides the cassette from the cassette holding portion to the upper surface of the cassette rack, by moving in the opposite direction to the first direction so that the cassette held by the cassette holding portion is held between the pair of claw portions, and moving in the first direction.

### (Note 43)

In the drug packaging system of Note 42,

the cassette holding portion includes lock portions that lock holding of the cassette in the cassette holding portion, and

when conveying the cassette, which is before being supplied to the cassette holding portion, from the cassette rack to the cassette holding portion, the second conveyor causes the lock portions to lock the holding of the cassette by sliding the cassette from the upper surface of the cassette rack to the cassette holding portion.

### (Note 44)

In the drug packaging system of Note 43,

when receiving the cassette held by the cassette holding portion from the cassette holding portion, the second conveyor cancels the lock of the holding of the cassette, which is achieved by the lock portions, by pushing cancel buttons for cancelling the lock of the holding of the cassette, which are provided to the cassette, with at least one of the pair of claw portions when the cassette is held between the pair of claw portions.

### (Note 45)

In the drug packaging system of any one of Notes 39 to 44,

the cassette rack includes a pair of first rollers, which are arranged apart from each other in a second direction intersecting with the first direction, and are movable so as to be separated from each other in the second direction,

the cassette has a shape with a width expanding in the first direction, and

when conveying the cassette, which is before being supplied to the cassette holding portion, from the cassette rack to the cassette holding portion, the second conveyor brings both surfaces of the cassette in the second direction into contact with the pair of first rollers by sliding the cassette in the opposite direction to the first direction, and separates the pair of first rollers apart from each other in the second direction by further sliding the cassette in the opposite direction to the first direction under a state in which both surfaces of the cassette in the second direction are in contact with the pair of first rollers.

### (Note 46)

In the drug packaging system of Note 45,

the cassette rack includes a pair of second rollers, which are arranged apart from each other in the second direction on a side of the pair of first rollers in the opposite direction to the first direction, and are movable so as to be separated from each other in the second direction, and

when conveying the cassette, which is before being supplied to the cassette holding portion, from the cassette rack to the cassette holding portion, the second conveyor brings both surfaces of the cassette in the second direction into contact with the pair of second rollers by sliding the cassette in the opposite direction to the first direction under a state in which both surfaces of the cassette are in contact with the pair of first rollers, and separates the pair of second rollers from each other in the second direction by further sliding the cassette in the opposite direction to the first direction under a state in which both surfaces of the cassette in the second direction are in contact with the pair of second rollers.

### (Note 47)

In the drug packaging system of Note 46, a second distance between the pair of second rollers is longer than a first distance between the pair of first rollers.

### 10. Supplementary Note

The embodiment disclosed herein is illustrative in all aspects and is not limiting. The scope of the present invention is defined by the claims rather than the embodiment described above, and includes all changes within the meaning equivalent to the claims and the range thereof.

1. A drug packaging system, comprising:
a first storage area that stores a cassette containing drugs and dispenses the drugs from the stored cassette;
a second storage area that stores the cassette to be conveyed to the first storage area;
a first conveyor that conveys the cassette within the second storage area;
a second conveyor that conveys the cassette from the second storage area to the first storage area; and
a packaging unit that packages the drugs dispensed from the cassette stored in the first storage area into a package for each dosage unit.

2. The drug packaging system according to claim 1, wherein
the second storage area comprises:
a first accommodating position at which the cassette introduced from an outside of the drug packaging system into the drug packaging system is accommodated; and
a second accommodating position at which the cassette to be conveyed to the first storage area is accommodated, and
the first conveyor conveys the cassette from the first accommodating position to the second accommodating position.

3. The drug packaging system according to claim 2, wherein
the second accommodating position is arranged between the first storage area and the first accommodating position.

4. The drug packaging system according to claim 3, wherein
the first storage area comprises a plurality of first storage areas aligned in a first direction, and
the first accommodating position is arranged in a second direction intersecting with the first direction from the plurality of first storage areas.

5. The drug packaging system according to claim 4, wherein
the second accommodating position comprises a plurality of second accommodating positions provided so as to correspond to the plurality of first storage areas.

6. The drug packaging system according to claim 1, wherein
the second conveyor pushes the cassette from the second storage area into the first storage area.

7. The drug packaging system according to claim 1, wherein
the first storage area comprises a storage cylinder having a columnar shape and being rotatable in a circumferential direction.

8. The drug packaging system according to claim 7, wherein
the storage cylinder comprises a plurality of cassette accommodating portions, each being capable of accommodating a cassette,
the plurality of cassette accommodating portions are arranged in the circumferential direction of the storage cylinder, and
the second conveyor conveys the cassette from the second storage area to one of the plurality of cassette accommodating portions.

9. The drug packaging system according to claim 8, wherein
the plurality of cassette accommodating portions are allowed to pass through a loading position in order based on rotating the storage cylinder in the circumferential direction, and
the second conveyor loads the cassette to the cassette accommodating portions located at the loading position, by conveying the cassette from the second storage area to the loading position.

10. The drug packaging system according to claim 7, further comprising
a third storage area that stores a cassette containing drugs and dispenses the drugs from the stored cassette, wherein
the storage cylinder comprises a plurality of storage cylinders aligned in a first direction, and
the third storage area is positioned in a space defined by adjacent two of the storage cylinders.

11. The drug packaging system according to claim 10, further comprising
a supply unit that supplies the drugs dispensed from the cassette stored in the first storage area and the drugs dispensed from the cassette stored in the third storage area, to the packaging unit.

12. The drug packaging system according to claim 10, wherein
the cassette stored in the first storage area comprises a first cassette containing a same type of drugs, and
the cassette stored in the third storage area comprises a second cassette containing drugs selectable from a plurality of types of drugs.

13. The drug packaging system according to claim 12, further comprising
a third conveyor that conveys the second cassette to the third storage area through a second conveyance path that is different from a first conveyance path through which the first cassette is to be conveyed by the first conveyor.

14. The drug packaging system according to claim 13, wherein
the first storage area is positioned between the first conveyance path and the second conveyance path,
the second storage area is in proximity to a first portion of the first storage area, the first portion being close to the first conveyance path, and
the third storage area is in proximity to a second portion of the first storage area, the second portion being close to the second conveyance path.

15. The drug packaging system according to claim 14, further comprising
a casing that accommodates the first storage area, the second storage area, and the third storage area, wherein
the casing comprises a first surface, a second surface, and a third surface,
the first surface and the second surface face each other,
the third surface connects the first surface and the second surface,
the first conveyance path is closer to the first surface than the first storage area,
the second conveyance path is closer to the second surface than the first storage area, and
the third surface comprises:
a first transfer opening that receives the first cassette conveyed through the first conveyance path; and
a second transfer opening that receives the second cassette conveyed through the second conveyance path.

16. A drug packaging system, comprising:
a storage cylinder having a columnar shape and being rotatable in a circumferential direction, the storage cylinder that stores a plurality of cassettes containing drugs and dispenses the drugs from the stored cassettes;
a storage area, which is adjacent to the storage cylinder, and in which a plurality of cassettes are allowed to be stored;
a conveyor that conveys the cassette between the storage cylinder and the storage area; and
a packaging unit that packages the drugs dispensed from the cassette stored in the storage cylinder, in a packaging body.

17. The drug packaging system according to claim 2, wherein
the first storage area comprises a storage cylinder having a columnar shape and being rotatable in a circumferential direction.

18. The drug packaging system according to claim 3, wherein
the first storage area comprises a storage cylinder having a columnar shape and being rotatable in a circumferential direction.

19. The drug packaging system according to claim 4, wherein
the first storage area comprises a storage cylinder having a columnar shape and being rotatable in a circumferential direction.

20. The drug packaging system according to claim 5, wherein
the first storage area comprises a storage cylinder having a columnar shape and being rotatable in a circumferential direction.
